(19) United States
(12) Patent Application Publication
(10) Pub. No.: US 2026/0092009 A1
(43) Pub. Date: Apr. 2, 2026

(54) ECO-SMART AND COST-EFFECTIVE ULTRA-HIGH PERFORMANCE CONCRETE

(71) Applicant: Cleveland State University, Cleveland, OH (US)

(72) Inventors: Srinivas Allena, Broadview Heights, OH (US); Chandrasekhar Kothapalli, Brecksville, OH (US)

(21) Appl. No.: 19/344,932

(22) Filed: Sep. 30, 2025

Related U.S. Application Data
(60) Provisional application No. 63/700,949, filed on Sep. 30, 2024.

(51) Int. Cl. C04B 28/04; C04B 14/06; C04B 14/08; C04B 14/10; C04B 14/28; C04B 14/48; C04B 18/08; C04B 18/14; C04B 103/30

(52) U.S. Cl. CPC C04B 28/04; C04B 14/06; C04B 14/08; C04B 14/106; C04B 14/28; C04B 14/48; C04B 18/08; C04B 18/141; C04B 18/146; C04B 2103/302

(57) ABSTRACT

Cost-effective and sustainable ultra-high performance concrete mixtures incorporate ground granulated blast furnace slag (GGBFS), limestone powder (LP), diatomaceous earth (DE), and/or metakaolin (MK). The composition may include portland cement, sand, ground granulated blast furnace slag, limestone powder, silica fume, and fly ash. The composition may alternatively include portland cement, sand, silica fume, metakaolin, and diatomaceous earth. The powder composition may be mixed with steel fibers, a water reducing mixture, and water. A ratio of limestone power to sand may be 1:15 to 1:7 or 1:10 to 1:8. A ratio of ground granulated blast furnace slag to portland cement may be 1:1 to 1:7 or 1:2 to 1:5.

This application claims priority to U.S. Provisional Application Ser. No. 63/700,949, filed Sep. 30, 2024, the contents of which are incorporated by reference herein.

### BACKGROUND

In the field of concrete technology, ongoing advancements have been a hallmark for decades. Recently, Ultra-High Performance Concrete (UHPC) has emerged as a promising construction material because of its excellent mechanical and durability properties. UHPC is an advanced fiber reinforced composite material characterized by compressive strengths exceeding 120 MPa and sustained post-cracking tensile strength greater than 15 MPa. UHPC combines the characteristics of three specialized concrete types: self-consolidating concrete's flow and passing abilities, high-performance concrete's strength, and fiber-reinforced concrete's ductility and post-cracking strength. The superior durability properties of UHPC can extend the service life of structures to more than two hundred years, which is two- to three-fold greater than the service life of the structures made with normal strength concrete. Additionally, the high mechanical strength of UHPC can facilitate significant reductions in the size of concrete elements. Field cast UHPC is used in connections between prefabricated bridge elements, pile cap closure pores, bridge deck overlays and repairs, and as a grout for bridge shear keys. In addition to bridge applications, building components such as cladding and roof components have been UHPC applications in the last decade. UHPC has also been used widely to repair and protect hydraulic structures and high-speed railways.

UHPC mixtures are typically produced with a very high cementitious materials content, around 40% to 50% per cubic yard of UHPC and a low water-to-cementitious materials ratio (w/cm) using only cement and silica fume (SF) as the cementitious components. The common guideline to produce UHPC include removal of coarse aggregate and use of fine sand (particle size <600 μm) to enhance mixture homogeneity, addition of steel fibers to improve ductility, application of pre-setting pressure and post-setting heat treatment to improve mechanical properties and microstructure, addition of SF to improve density and produce secondary calcium silicate hydrates, and inclusion of high range water reducing admixtures (HRWRAs) to facilitate a low w/cm ratio with enough workability for placement and consolidation.

Materials being used in UHPC are often shipped long distances, internationally in most cases, increasing the overall cost. Additionally, strict requirements on the chemistry of the cement and SF increase the cost of commercially available, prepackaged UHPC products. Furthermore, the cement content used in UHPC mixtures is approximately three times that of conventional concrete (800-1000 kg/m³), which creates sustainability challenges as cement production is an energy intensive process that contributes to CO₂ emissions. Therefore, despite its remarkable performance, UHPC is viewed as a concrete product with substantial energy consumption, which runs counter to the prevailing trends in sustainable development. Consequently, there is a strong impetus to create a more environmentally friendly UHPC that is cost-effective and has a reduced carbon footprint, aiming to enhance its acceptance and broaden its application in structural engineering. Complete hydration of cement with low w/cm ratio and high cementitious material is a challenge. Unhydrated cement acts as an expensive filler in the binder system.

It would be desirable to develop new, modified UHPC materials that offer cost and/or environmental benefits.

Ultra-high performance concrete (UHPC) represents a significant milestone in concrete innovation, offering unprecedented mechanical strength and durability performance characteristics. According to ASTM C1856, meeting the criteria for UHPC necessitates maintaining a flow range of 8-10 inches (203 to 254 mm), with a nominal maximum aggregate size not exceeding ¼ inch (6.35 mm). Furthermore, it must exhibit a minimum compressive strength of 17,000 psi (120 MPa). Typical UHPC mixtures consist of a high proportion of cement along with silica fume, quartz powder, quartz sand, and steel fibers. Incorporating fibers enhances the ductility and ability to withstand bending stress. It can exhibit a flexural strength of up to 2,500 psi (18 MPa) and negligible long-term creep. Moreover, UHPC demonstrates resilience against freeze-thaw cycles and salt-induced scaling, exhibiting no visible deterioration and it possesses high resistance to chloride-ion penetration, making it nearly impermeable. These exceptional characteristics are achieved by enhancing uniformity, eliminating coarse aggregate, optimizing packing density, refining microstructure, and integrating fibers. This combination represents a synergistic blend of three concrete technologies: self-compacting concrete (SCC) for flow, fiber-reinforced concrete (FRC) for ductility, and high-performance concrete (HPC) for strength and durability. However, despite its many benefits, its wide applicability is hindered due to its high initial cost. The high cost of UHPC is mainly associated with the cost of its constituents such as cement, silica fume, quartz powder, quartz sand, superplasticizer, and steel fibers. Additionally, the manufacturing process requires stringent quality control measures and specialized equipment, leading to increased initial costs.

Currently, UHPC is used in applications span a wide range of applications, including bridge decks, architectural facades, high-rise buildings, precast elements, and seismic-resistant structures. Beyond infrastructure applications, this material can also be used in nuclear applications (e.g., nuclear waste depositories) as grout for encapsulating solid and liquid secondary radioactive waste and disposal infrastructure. Moreover, the extensive use of cement with a high content in proprietary UHPC not only increases the cost but also raises environmental concerns. The cement content used in UHPC mixtures is approximately three times that of conventional concrete, which poses sustainability challenges as cement production is an energy intensive process that contributes to CO₂ emissions. One ton of portland cement releases about 0.87 to 1 ton of CO₂, and the whole cement industry contributes to around 8-9% of the anthropogenic CO₂ emissions and 2-3% (4-5 GJ/ton) energy consumption.

Silica fume (SF) is primary supplementary cementitious material (SCM) in UHPC, comprising 5% to 25% of the binder volume. SF enhances UHPC's particle packing density, improving workability due to its fine particle size. However, exceeding 10% can significantly reduce workability due to SF's high surface area, leading to water and HRWRA absorption, particle agglomeration, and inhibition of cement reaction. With a SiO₂ content above 90%, SF stimulates cement hydration and refines UHPC's microstructure, enhancing mechanical strengths and durability. Despite its effectiveness, use of SF in UHPC mixtures is expensive compared to other SCMs since it is mostly imported.

The high quantities of cement and expensive SF significantly increases the cost of UHPC and is less desirable from an environmental standpoint. Besides its higher cost, exposure to SF in occupational settings increases the risk of developing pulmonary diseases, including silicosis, tuberculosis, chronic bronchitis, chronic obstructive pulmonary disease, and lung cancer. Therefore, exploring feasible alternatives to SF is crucial for UHPC production sustainability. Several alternative SCMs commonly used in UHPC instead of SF include fly ash (FA), ground granulated blast furnace slag (GGBS), metakaolin (MK), and rice husk ash (RHA). Among these SCMs, FA has gained significant recognition as a key SCM by construction industry. Numerous researchers have concentrated on formulating new UHPC mixtures incorporating FA due to its potential to diminish the environmental impact when substituted for cement. The incorporation of FA not only lowers CO₂ emissions due to cement usage but also reduces concrete production costs and energy consumption. FA, used in place of cement at ratios of 10% to 30%, enhances concrete workability due to its spherical shape, reducing inter-particle friction. Limited studies on UHPC explored replacing portland cement with FA, focusing on compressive and flexural strength up to 47% cement substitution. Despite a slight reduction in mechanical properties, FA-based UHPC improves workability and particle packing, potentially enhancing durability. However, the production of class F fly ash has experienced a significant decline due to the shift towards renewable energy technologies for electricity generation and the decommissioning of coal-burning power stations. Consequently, the construction sector is grappling with difficulties in procuring a sufficient supply of fly ash for concrete manufacturing. Hence, it becomes imperative to identify an alternative SCM to FA to ensure the sustainability.

### BRIEF DESCRIPTION

The present disclosure is directed to eco-smart and cost-effective ultra-high performance concrete.

Disclosed, in some embodiments, is a cementitious powder composition containing: portland cement; sand; and at least one material selected from the group consisting of ground granulated blast furnace slag, limestone powder, diatomaceous earth, and metakaolin. In particular embodiments, the composition includes any one, two, three, or all four of the at least one materials selected from the group. In particular embodiments, the at least one material includes ground granulated blast furnace slag and limestone powder. In particular embodiments, the at least one material includes diatomaceous earth and metakaolin. The composition may or may not contain fly ash. The composition may or may not contain silica fume. A cement composition may be formed by mixing the cementitious powder composition with steel fibers, a high-range water reducing admixture, and water.

Disclosed, in other embodiments, is a cementitious powder composition including: portland cement; sand; ground granulated blast furnace slag; limestone powder; silica fume; and fly ash. Non-limiting examples of weight ratios of limestone powder to sand include about 1:100 to about 1:4; about 1:20 to about 1:6; about 1:15 to about 1:7; about 1:10 to about 1:8; and about 1:9. Non-limiting examples of weight ratios of ground granulated blast furnace slag to portland cement include about 2:1 to about 1:10; about 1:1 to about 1:7; about 1:2 to about 1:5; and about 1:3. A cement composition may be formed by mixing the cementitious powder composition with steel fibers, a high-range water reducing admixture, and water.

Disclosed, in further embodiments, is a cementitious powder composition containing: portland cement; sand; silica fume; metakaolin; and diatomaceous earth. The composition may or may not include fly ash. In particular embodiments, the composition contains from about 1 wt % to about 3 wt % fly ash. The amount of diatomaceous earth in the composition may be in a range of about 0.1 wt % to about 10 wt %; about 0.5 wt % to about 8 wt %; about 1 wt % to about 6 wt %; or about 3 wt % to about 5 wt %. The amount of metakaolin in the composition may be in a range of about 0.1 wt % to about 10 wt %; about 0.5 wt % to about 8 wt %; about 1 wt % to about 6 wt %; or about 3 wt % to about 5 wt %. A weight ratio of the metakaolin to the diatomaceous earth may be in a range of about 1:10 to about 10:1, about 1:9 to about 9:1, about 1:8 to about 8:1, about 1:7 to about 7:1, about 1:6 to about 6:1, about 1:5 to about 5:1, about 1:4 to about 4:1, about 1:3 to about 3:1, about 1:2 to about 2:1, or about 1:1. A cement composition may be formed by mixing the cementitious powder composition with steel fibers, a high-range water reducing admixture, and water.

These and other non-limiting aspects of the disclosure are more particularly set forth below.

### BRIEF DESCRIPTION OF THE DRAWINGS

FIG. 1. Particle size distribution of OPC, SF, FA, GGBFS and LP.

FIG. 2. Mixing procedure for UHPC.

FIG. 3. Measuring flow of fresh UHPC.

FIG. 4. Test setup for 2-inch cube compressive strength.

FIG. 5. Flexural strength test set up.

FIG. 6. Drying and autogenous shrinkage samples (covered with aluminum foil to prevent moisture loss).

FIG. 7. Effect of LP dosage on workability of UHPC mixtures.

FIG. 8. Compressive strengths of UHPC mixtures without and with GGBFS and with LP dosages varying from 0%-20% cured under MC and WB regimen for seven and 28-days.

FIG. 9. Load versus net deflection curve for UHPC mixture with GGBFS mixtures with LP 0%-20%.

FIG. 10. Load versus net deflection curve for UHPC mixture without GGBFS mixtures with LP 0%-20%.

FIG. 11. First peak strength for UHPC mixtures with and without GGBFS.

FIG. 12. Peak flexural strength for UHPC mixtures with and without GGBFS.

FIG. 13. Residual flexural strengths of UHPC mixtures with and without GGBFS at L/600 deflection

FIG. 14. Residual flexural strengths of UHPC mixtures with and without GGBFS at L/150 deflection

FIG. 15. Toughness values of UHPC mixtures (a) with GGBFS and (b) without GGBFS.

FIG. 16. Autogenous shrinkage of UHPC mixtures (a) with GGBFS and (b) without GGBFS.

FIG. 17. Drying shrinkage for UHPC mixture (a) with GGBFS and (b) without GGBFS.

FIG. 18. Comparison of cement consumption index of UHPC mixtures developed in this study with other studies.

FIG. 19: SEM images of raw materials of (a) Cement (b) Fly ash (c) Metakaolin (d) Diatomaceous earth (e) Condensed Silica fume

FIG. 20: Optimization process of UHPC mixtures

FIG. 21: Mixing procedure for fresh UHPC

FIG. 22: Effect of MK content on HRWRA dosage and seven-day compressive strength of UHPC mixtures.

FIG. 23: Effect of DE content on HRWRA dosage and seven-day compressive strength of trail UHPC mixtures.

FIG. 24: SEM imaging of DE powder containing different diatoms with different pore structures

FIG. 25: Seven-day compressive strengths of MK-DE modified UHPC mixtures cured under both MC and WB curing regimens.

FIG. 26: Compressive strength of MK, DE, and MK-DE-modified UHPC mixtures cured under MC curing regimen.

FIG. 27: Compressive strength of MK, DE, and MK-DE-modified UHPC mixtures cured under WB curing regimen.

FIG. 28: Relative gain of compressive strength with time in MC curing regimen

FIG. 29: Compressive strength of 2 in. and 4 in. cube specimens cured under MC and WB regimens for 3, 7, 28, and 56 days.

FIG. 30: Load-deflection curves for (a) MC cured specimens at seven days; (b) MC cured specimens at 28 days; (c) WB cured specimens at seven days; and (d) WB cured specimens at 28 days.

FIG. 31: Comparison of seven and 28-day (a) first peak strength (MOR) and (b) peak strengths of control, Mk-, DE, and MK-DE modified UHPC mixtures cured under MC and WB regimens.

FIG. 32: Residual flexural strength (a) at L/600 deflection; and (b) at L/150 deflection

FIG. 33: Toughness of UHPC mixtures at 28 days at (a) L/600 deflection; and (b) L/150 deflection

FIG. 34: Equivalent flexural strengths (a) at L/600 deflection; and (b) at L/150 deflection

FIG. 35: the 10 UHPC mixture proportions developed in the examples

### DETAILED DESCRIPTION

The present disclosure may be understood more readily by reference to the following detailed description of desired embodiments and the examples included therein. In the following specification and the claims which follow, reference will be made to a number of terms which shall be defined to have the following meanings.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

The term “comprising” is used herein as requiring the presence of the named components/steps and allowing the presence of other components/steps. The term “comprising” should be construed to include the term “consisting of”, which allows the presence of only the named components/steps.

Numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values). The endpoints of the ranges and any values disclosed herein are not limited to the precise range or value; they are sufficiently imprecise to include values approximating these ranges and/or values.

The modifier “about” used in connection with a quantity is inclusive of the stated value and has the meaning dictated by the context. When used in the context of a range, the modifier “about” should also be considered as disclosing the range defined by the absolute values of the two endpoints. For example, the range of “from about 2 to about 10” also discloses the range “from 2 to 10.” The term “about” may refer to plus or minus 10% of the indicated number. For example, “about 10%” may indicate a range of 9% to 11%, and “about 1” may mean from 0.9-1.1.

The present disclosure is directed to eco-smart and cost-effective ultra-high performance concrete.

Disclosed, in some embodiments, is a cementitious powder composition containing: portland cement; sand; and at least one material selected from the group consisting of ground granulated blast furnace slag, limestone powder, diatomaceous earth, and metakaolin. In particular embodiments, the composition includes any one, two, three, or all four of the at least one materials selected from the group. In particular embodiments, the at least one material includes ground granulated blast furnace slag and limestone powder. In particular embodiments, the at least one material includes diatomaceous earth and metakaolin. The composition may or may not contain fly ash. The composition may or may not contain silica fume. A cement composition may be formed by mixing the cementitious powder composition with steel fibers, a high-range water reducing admixture, and water.

Disclosed, in other embodiments, is a cementitious powder composition including: portland cement; sand; ground granulated blast furnace slag; limestone powder; silica fume; and fly ash. Non-limiting examples of weight ratios of limestone powder to sand include about 1:100 to about 1:4; about 1:20 to about 1:6; about 1:15 to about 1:7; about 1:10 to about 1:8; and about 1:9. Non-limiting examples of weight ratios of ground granulated blast furnace slag to portland cement include about 2:1 to about 1:10; about 1:1 to about 1:7; about 1:2 to about 1:5; and about 1:3. A cement composition may be formed by mixing the cementitious powder composition with steel fibers, a high-range water reducing admixture, and water.

Disclosed, in further embodiments, is a cementitious powder composition containing: portland cement; sand; silica fume; metakaolin; and diatomaceous earth. The composition may or may not include fly ash. In particular embodiments, the composition contains from about 1 wt % to about 3 wt % fly ash. The amount of diatomaceous earth in the composition may be in a range of about 0.1 wt % to about 10 wt %; about 0.5 wt % to about 8 wt %; about 1 wt % to about 6 wt %; or about 3 wt % to about 5 wt %. The amount of metakaolin in the composition may be in a range of about 0.1 wt % to about 10 wt %; about 0.5 wt % to about 8 wt %; about 1 wt % to about 6 wt %; or about 3 wt % to about 5 wt %. A weight ratio of the metakaolin to the diatomaceous earth may be in a range of about 1:10 to about 10:1, about 1:9 to about 9:1, about 1:8 to about 8:1, about 1:7 to about 7:1, about 1:6 to about 6:1, about 1:5 to about 5:1, about 1:4 to about 4:1, about 1:3 to about 3:1, about 1:2 to about 2:1, or about 1:1. A cement composition may be formed by mixing the cementitious powder composition with steel fibers, a high-range water reducing admixture, and water.

Ground granulated blast-furnace slag (GGBFS) is a highly cementitious byproduct of iron extraction in a blast furnace, and is a suitable alternative for cement, FA, and SF in UHPC. It is abundant in silica and alumina phases. Its inclusion to partially replace cement has been explored due to its hydraulic behavior, as it reacts with water and produces calcium silicate hydrate (C—S—H) gel, contributing to the strength and durability of concrete. GGBFS used to replace cement up to 60 wt. % led to an increase in compressive strength of up to 10% after 28 days of curing. When FA, GGBFS, and LP were used as partial replacements for cement, up to 30% by mass, the UHPC mixtures containing GGBFS exhibited superior mechanical properties compared to those containing FA or LP. Hydration rate in UHPC mixtures containing GGBFS is typically greater than those containing FA. This is due to the fact that the pozzolanic reaction of FA can be inhibited in the specific cementitious system of UHPC, which typically features a very low water-to-cement ratio and a high dosage of HRWRA. As a result, only a limited amount of FA can react with the available calcium hydroxide.

Another potential candidate for the partial replacement for cement is LP. Since UHPC is developed with low w/cm ratio (<0.20) and high cementitious materials content, complete hydration of cement is not possible, which suggests that the remaining cement would remain unhydrated and acts as expensive filler in the system. Consequently, there is interest in replacing a portion of the cement with SCMs. LP replacement ratio can be high in UHPC since more than half of the cement in UHPC is simply used as a physical filler. Efforts to use GGBFS, FA, and rice husk ash as alternatives to SCMs are limited due to availability. LP as a partial replacement to cement can significantly contribute to the economic and environmental production of cement-based materials, due to advantages such as stable supply, ease of quality control, worldwide availability, and reasonable price. LP was used to replace cement and SF in UHPC, and although the workability and mixing time were improved, the compressive strength of UHPC decreased with increasing LP content. The degree of secondary pozzolanic hydration of LP with SF is more intensive than C₃S or C₂S hydration that enhances the later-age strength development potential, with the optimum LP dosage being around 50%. Replacing cement with LP (<74%) promoted cement hydration, which is encouraging because the hydration degree of typical UHPC with a low w/cm ratio can be as low as 35%, and the unhydrated cement remains as expensive filler, which is uneconomical. However, increasing LP content also increases porosity and decreases compressive strength.

MK, produced by calcining kaolin clay, is commonly utilized as SCM in concrete, replacing 8% to 10% of cement. Its inclusion enhances concrete durability while reducing cement usage. Studies have shown MK can replace up to 20% of cement, improving split tensile strength, with peak compressive strength achieved at 16% replacement. However, MK and silica fume addition decrease concrete workability. Yet, at 15% cement replacement, compressive strengths remain comparable to control samples after 91 days, exhibiting excellent corrosion resistance and reduced shrinkage. MK reacts with calcium hydroxide during cement hydration, forming secondary cementitious compounds like calcium silicate hydrates (C—S—H) gel, enhancing concrete microstructure and durability by reducing porosity and improving permeability and chloride ion diffusion. Numerous studies have investigated various types of concretes and mortars replacing cement and SF with MK, but there is a lack of research specifically focused on UHPC incorporating MK to replace fly ash. This gap in the literature fails to highlight the beneficial impact of MK on the mechanical and durability properties of UHPC, as well as its contribution to the sustainability. This study aimed to explore the potential for replacing fly ash and silica fume with cost-effective and environmentally friendly alternatives for UHPC mixtures. To achieve this, in this research, two SCMs known for their sustainable attributes, metakaolin (MK) and diatomaceous environmentally friendly substitute the FA and MK to diversify SCM options in UHPC formulations. The research focused on evaluating the effects of replacing fly ash and silica fume with MK and DE on the rheological and mechanical properties of UHPC mixtures.

Diatomaceous earth (DE) which is a natural pozzolan emerges as a potential alternative SCM to fly ash, given its high silica content. However, while DE has been extensively studied in conventional and pervious concrete, its application in Ultra-High Performance Concrete (UHPC) remains largely unexplored. Incorporating DE in concrete mixtures improves compressive strength, capillary pore volume, resistance to chloride ion ingress, and resistance to alkali-aggregate reaction. However, it may reduce resistance to freezing-thawing cycles and scaling. Conversely, replacing cement with DE in mortar mixes may decrease compressive strength and increase water absorption. More research is needed to understand the optimal use of DE as an SCM, particularly in UHPC formulations, to fully assess its potential benefits and drawbacks.

### Examples

Experiments were conducted to understand the effects of LP as a partial replacement for cement in UHPC mixtures by replacing either 0% or 25% by weight of cement with GGBFS while LP dosage was varied from 0% to 20% by weight of cement. Workability, mechanical properties, and drying and autogenous shrinkage were evaluated.

Type I/II ordinary portland cement (OPC) and commercially available SF, GGBFS, and LP were used for this research. Physical and chemical properties of these materials are presented in Table 1. Locally available sand with maximum particle size of 4.75 mm (ASTM #4) was used. The particle size range of LP used in this study was 44 to 841 microns. 13 mm long straight steel fibers with an aspect ratio of 65 were added to the mixtures to improve ductility. Commercially available polycarboxylate based HRWRA was used to achieve desired workability.

TABLE 1
Chemical composition and physical properties
of cementitious materials used.

| Chemical | | Silica | Fly | | |
|---|---|---|---|---|---|
| compounds (%) | Cement | Fume | Ash | GGBFS | LP |
| SiO₂ | 20.2 | 96.9 | 38.03 | 30-40 | 1 |
| Al₂O₃ | 4.3 | 0.2 | 18.44 | 7-18 | 0.15 |
| Fe₂O₃ | 2.8 | 0.2 | 5.16 | 0.1-1.8 | 0.15 |
| CaO | 63.8 | 0.3 | 16.05 | 30-50 | — |
| MgO | 1.6 | 0.2 | 3.73 | 2-14 | — |
| SO₃ | 0.35 | 0.1 | 3.3 | 2.5 | — |
| Na₂O | — | 0.2 | 9.2 | — | — |
| K₂O | — | 0.3 | 0.96 | — | — |
| MgCO3 | — | — | — | — | 44.3 |
| CaCO₃ | — | — | — | — | 54.2 |
| Ca(SO₄)•2H₂O | | | | ≤2 | |
| Mn | | | | ≤1 | |
| S | — | — | — | 1 | — |
| Loss on ignition | 0.88 | 2.17 | 2.1 | ≤2 | — |
| Insoluble residue | 0.34 | — | — | — | — |
| Relative density | 3.15 | 2.24 | 2.58 | 2.91 | 1.28 |
| moisture content | — | 0.04 | 0.2 | — | 0.2 |
| (%) | | | | | |
| Blane fineness | 401 | — | — | 542 | — |
| (m²/kg) | | | | | |

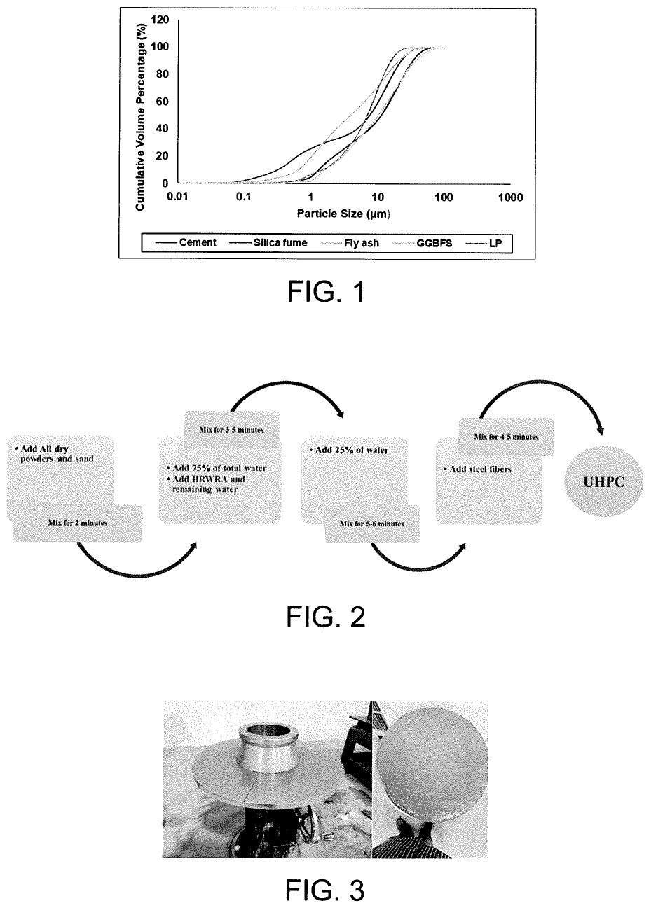

FIG. 1 shows the particle size distribution of OPC, SF, FA, GGBFS and LP. The GGBFS has a particle size distribution ranging from approximately 0.01 to 56 micrometers, similar to OPC (0.05-71 micrometers). Similarly, FIG. 1 indicates that LP has a particle size distribution range from 0.01-36 micrometers. This particle size distribution allows GGBFS and LP to integrate seamlessly within the existing particle framework of UHPC mixture with OPC. The use of fine fillers like LP and SCMs such as GGBFS, FA and SF can improve the packing density, leading to improved mechanical properties and durability of the concrete mix.

### Mixture Proportioning

Two control UHPC mixtures were developed, one without GGBFS and another with GGBFS replacing 25% of cement both without LP. These two mixtures were modified by partially substituting cement with LP, with replacement levels ranging up to 20% by mass of cement, in order to ascertain the optimal LP dosage. This yielded a total of eight mixtures, which included the original two control mixtures. SF and FA were the other two SCM's employed in these mixtures, and their quantities remained the same for all eight mixtures.

FA was utilized to substitute a portion of the expensive SF, contributing to enhanced sustainability. Each mixture is designated with an alphanumeric code that indicates the presence of GGBFS and LP, along with their respective replacement percentages. For instance, the mixture C-S25-LP10 denotes a composition with cement (C) having 25% replaced by GGBFS (S25) and 10% replaced by LP (LP10). The mixture proportions of these eight mixtures are presented in Table 2.

TABLE 2
Mixture proportion of control UHPC mixtures.

| | | | | | | | | | | |
|---|---|---|---|---|---|---|---|---|---|---|
| | | | | | | | Steel | | | |
| | Cement | SF | GGBFS | FA | LP | Sand | fibers | HRWRA | Water | |
| Mixture | kg/m³ | kg/m³ | kg/m³ | kg/m³ | kg/m³ | kg/m³ | kg/m³ | l/m³ | kg/m³ | w/cm |

UHPC mixtures without GGBFS

| | | | | | | | | | | |
|---|---|---|---|---|---|---|---|---|---|---|
| C-S0-LP0 | 900 | 69 | 0 | 103 | 0 | 1095 | 120 | 44.5 | 160 | 0.15 |
| C-S0-LP10 | 810 | 69 | 0 | 103 | 90 | 973 | 120 | 44.5 | 160 | 0.15 |
| C-S0-LP15 | 765 | 69 | 0 | 103 | 135 | 920 | 120 | 44.5 | 160 | 0.15 |
| C-S0-LP20 | 720 | 69 | 0 | 103 | 180 | 864 | 120 | 44.5 | 160 | 0.15 |

UHPC mixtures with GGBFS

| | | | | | | | | | | |
|---|---|---|---|---|---|---|---|---|---|---|
| C-S25-LP0 | 675 | 69 | 225 | 103 | 0 | 1080 | 120 | 44.5 | 160 | 0.15 |
| C-S25-LP10 | 608 | 69 | 225 | 103 | 68 | 985 | 120 | 44.5 | 160 | 0.15 |
| C-S25-LP15 | 574 | 69 | 225 | 103 | 101 | 944 | 120 | 44.5 | 160 | 0.15 |
| C-S25-LP20 | 540 | 69 | 225 | 103 | 135 | 903 | 120 | 44.5 | 160 | 0.15 |

### Specimen Preparation and Curing

A vertical shaft mixer operating at a paddle speed of 38 rpm was employed to blend the components of UHPC. Initially, the sand and cementitious materials were combined in a dry state.

After dry mixing for two minutes, 75% of the total water content was introduced into the mixer.

Following thorough mixing, HRWRA was added and blended for an additional five minutes. Subsequently, the remaining 25% of water was added and mixed for an additional 5-6 minutes.

A visual examination was conducted to ensure there were no clumps of dry powder remaining. Following the visual inspection, the mixture was allowed to run for an additional minute before the fibers were introduced. Once the fibers were added, the mixture was set to run for another 4-5 minutes until it exhibited a workable and homogenous appearance. The overall mixing duration ranged from 15 to 20 minutes, and FIG. 2 illustrates the sequential mixing steps. Subsequently, the workability of the freshly mixed UHPC was assessed by conducting a flow table test in accordance with ASTM C1437. To examine the impact of curing conditions on UHPC properties, this research explored two distinct curing regimens, with the specifics of these regimens provided in Table 3.

### Methods

### Workability

TABLE 3
Curing regimens used for compressive strength
and modulus of rupture tests.

| | Desig- | |
|---|---|---|
| Type | nation | Specification |
| Moist | MC | The specimens were left in the mold for a period of |
| curing | | 24 hours. Following demolding, they were sub- |
| | | sequently relocated to a curing room with controlled |
| | | temperature and humidity conditions until testing. |
| Warm | WB | The specimens were left in the molds for a period of |
| bath | | 24 hours. Following the demolding, the specimens |
| curing | | were then subjected to curing in a water bath |
| | | maintained at 90° C. until testing. |

The fresh UHPC was poured into the mold in two layers, with each layer being tamped 20 times. Following this, the top surface was smoothened. The mold was then lifted and immediately dropped onto the table 25 times within a 15-second period. Subsequently, the diameter of the fresh sample was measured in two diametrically opposite directions, and the average flow was recorded and reported. This procedure is outlined in ASTM C1437. The test setup and the UHPC flow resulting from the test are shown in FIG. 3.

### Compressive Strength

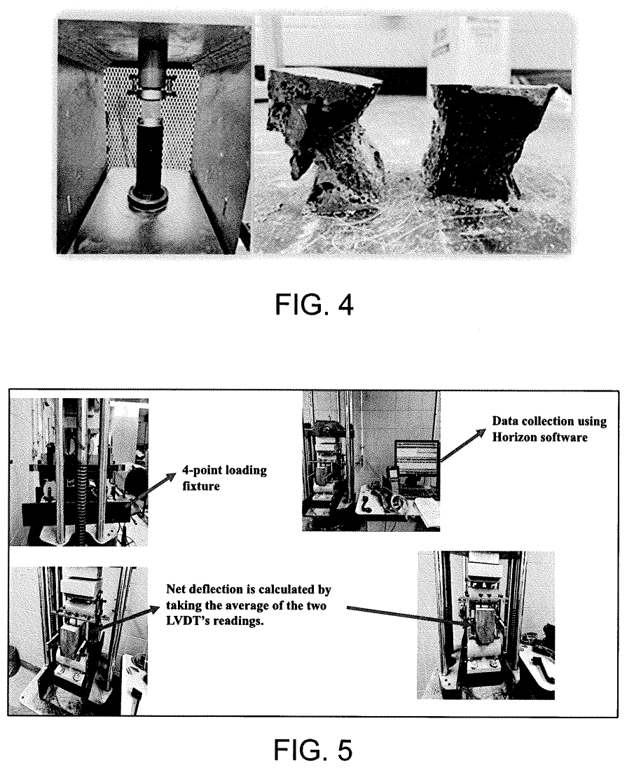

The compressive strength of UHPC was evaluated using 50 mm cubes according to ASTM C109 at seven and 28-days of curing. FIG. 4 illustrates the compression testing for cube specimens.

### Flexural Strength

Four prismatic specimens, each measuring 75×100×400 mm were cast for each mixture and cured under MC and WB curing regimens for 28 days to evaluate the flexural behavior of UHPC mixtures. FIG. 5 illustrates the test set up for flexural strength testing. Flexural strength testing was performed according to ASTM C1609.

From the test data, modulus of rupture (MOR) which is the first peak strength, peak stress, residual stress at L/600 and L/150 net deflections, where L is the effective length of the beam (305 mm), and toughness of UHPC mixtures were evaluated.

### Drying and Autogenous Shrinkage

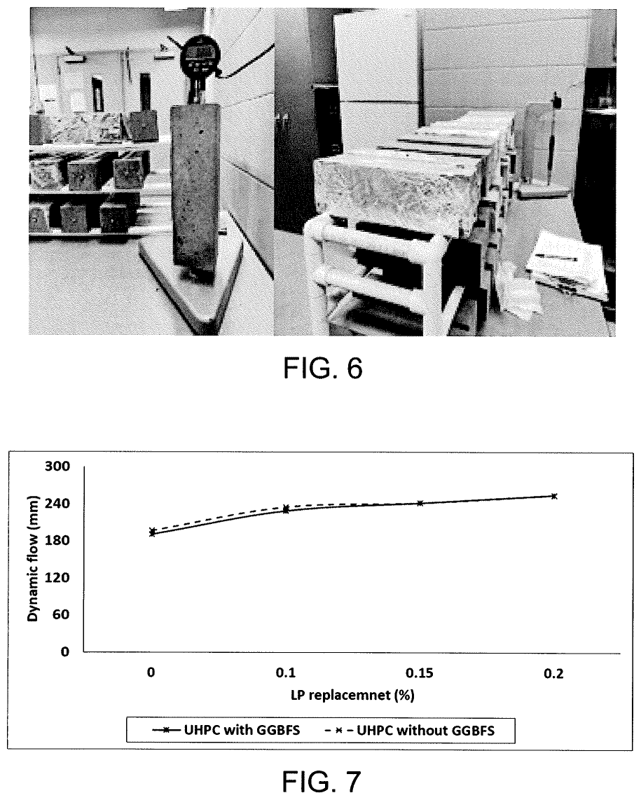

Two prismatic specimens, each measuring 75×75×285 mm were cast for each batch, with gauge studs inserted at the ends following ASTM C157, establishing a 250 mm effective length for shrinkage measurement. After casting, the specimens were left in the mold for 24 hours before being demolded. Subsequently, they were submerged in lime-saturated water for half an hour prior to taking the initial measurements. The initial length comparator readings were then recorded. The specimens were then placed in MC curing regimens for the next 2 days. After two days of curing, the specimens were left in the air at room temperature for the next 52 days. Length comparator readings were recorded every other day. The method for measuring autogenous shrinkage is similar to that of drying shrinkage with the exception that the specimens were covered with food-grade plastic wrap/aluminum foil after being saturated in lime water for 30 minutes to minimize the change in length due to change in temperature. FIG. 6 depicts the experimental set up for shrinkage measurement.

The value of shrinkage recorded on the 56^{th} day is considered as the ultimate shrinkage for the UHPC mixtures. The average of two samples was reported as final shrinkage strain which was calculated using equation 1:

$$Δ = ( {L}_{x} - {L}_{0} ) / 10 \qquad Equation 1$$

where, Lₓ represents the length comparator reading on the test date and L₀ is the initial length comparator reading.

### Cement Composition Index (CCI) and Clinker to Cement Ratio (CCR)

The CCI was calculated for the UHPC mixtures to determine the cement content required to give a unit compressive strength. Equation 2 was used to determine the CCI of the UHPC mixtures studied and compared with other studies.

$$CCI = ( Cement content in kg / m 3 / Maximum 28 - day compressive strength in MPa ) \qquad Equation 2$$

A graph correlating the LP content and the CCI was generated to investigate the potential of replacing unhydrated cement, typically underutilized in UHPC, with LP as a means to enhance the sustainability of UHPC. Substituting cement with LP not only harnesses LP's filler properties to enhance the microstructure of UHPC but also diminishes environmental impact by reducing cement consumption. Similarly, the CCR, which indicates the ratio of cement present in the mixture to the total powder content (cement, SCMs, and LP) was computed for all the UHPC mixtures with different LP dosages using Equation 3. This ratio serves as an indicator of the proportion of cement used in concrete production, thereby reflecting the amount of clinker required to produce the cement content of the mixture.

$$CCR = ( Mass of cement in the mixture ) / ( Mass of ( cement + SCMs + LP ) \qquad Equation 3$$

### Results and Discussion

### Workability

The effect of LP on workability (flow) of UHPC mixtures produced with and without GGBFS was studied with LP dosage ranging from 0% to 20% (FIG. 7). The addition of GGBFS did not significantly influence the flow of UHPC mixtures at 0% LP dosage. This observation can be explained by the marginal decrease in workability when GGBFS is introduced. Specifically, the workability of the UHPC mixture without GGBFS and without LP was only 3.33% greater than that of the mixture with GGBFS. This slight reduction in workability can be attributed to the improved particle size distribution and enhanced particle packing brought about by the inclusion of GGBFS as a partial replacement for cement.

The enhanced particle packing leads to better interlocking of particles within the mixture. While this improves the density and mechanical properties of the UHPC, it restricts the relative movement of the particles, thereby impeding flow during mixing. This restriction in flow results in a slight decrease in the spread, as observed in the flow test. Therefore, while GGBFS does not drastically change the flow properties, the marginal decrease is due to the physical characteristics of the particle interactions within the UHPC matrix.

As can be seen from FIG. 7, LP plays a significant role in improving the workability of UHPC. The workability of UHPC mixtures with and without GGBFS was increased by 33% and 30%, respectively when compared to the corresponding control mixtures (0% LP mixtures with and without GGBFS).

LP may be considered as mineral plasticizer that enhances the flowability of UHPC. This plasticization effect results from the repulsion between the OH— groups localized on the Ca²⁺ surface of LP and its lower water absorption. Furthermore, incorporating LP as a partial substitute for cement can increase the flowability of UHPC, primarily due to the higher water-to-cement ratio resulting from the replacement of a portion of cement with LP. Additionally, the workability of UHPC mixtures containing GGBFS was nearly identical to that of UHPC mixtures that did not incorporate GGBFS at any level of LP replacement.

### Compressive Strength

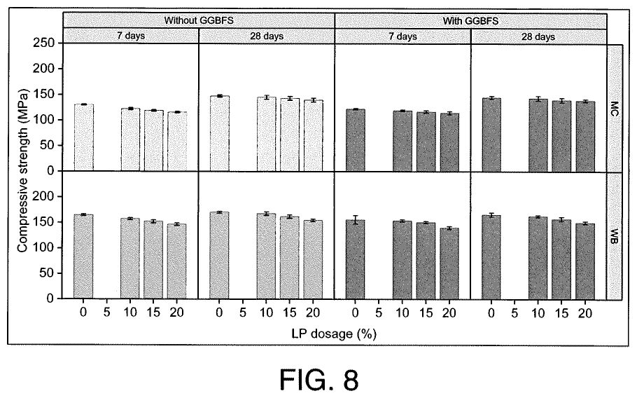

Compressive strength testing was performed on 50 mm cube specimens as per ASTM C109 after seven and 28 days of curing. FIG. 8 and Table 4 show the compressive strengths of UHPC mixtures after seven and 28 days. These mixtures were produced with and without GGBFS, cured under both MC and WB regimens, and included LP dosages ranging from 0% to 20% by mass of cement.

TABLE 4
Compressive strengths of UHPC mixtures without and
with GGBFS and with LP dosages varying from 0%-20%
cured under MC and WB regimen for seven and 28-days.

| | | With GGBFS | | Without GGBFS | |
|---|---|---|---|---|---|
| | | 7-day | 28-day | 7-day | 28-day |
| | | compressive | compressive | compressive | compressive |
| Curing | LP | strength | strength | strength | strength |
| regimen | (%) | (MPa) | (MPa) | (MPa) | (MPa) |
| MC | 0 | 122 | 144 | 130 | 147 |
| | 10 | 119 | 143 | 122 | 145 |
| | 15 | 117 | 139 | 119 | 143 |
| | 20 | 114 | 138 | 116 | 139 |
| WB | 0 | 155 | 166 | 164 | 171 |
| | 10 | 153 | 162 | 157 | 168 |
| | 15 | 150 | 157 | 152 | 161 |
| | 20 | 139 | 149 | 146 | 154 |

The early age (seven-day) compressive strengths of UHPC mixtures with GGBFS without LP showed 9% and 5.5% lower compressive strength under MC and WB curing regimen, respectively when compared with UHPC mixture without GGBFS and without LP (FIG. 8). The early age compressive strength for UHPC mixture without GGBFS was marginally lower compared to UHPC mixture without GGBFS. Addition of GGBFS tends to have lower early age strengths. However, the reduction in early age compressive strength when GGBFS is used as cement replacement can be offset by incorporating SF due to the synergy between GGBFS and SF. The early strength development in ternary mixes can be attributed to the highly reactive nature of SF particles, which significantly accelerate the hydration process within the concrete mix.

As depicted in FIG. 8, the compressive strengths of MC-cured UHPC mixtures without GGBFS decreased by 11% and 5% at seven and 28 days, respectively, when the LP dosage was increased to 20%. Similarly, the seven-day and 28-day compressive strengths of WB-cured specimens produced from these mixtures were decreased by 10.5% when the LP dosage was increased to 20% for both MC and WB curing regimen. The greatest 28-day compressive strength, which reached 171 MPa, was observed for the UHPC mixture without LP under the WB curing regimen. Among the LP replacement dosages, 10% LP replacement showed the greatest 28-day compressive strength of 168 MPa under the WB curing regimen.

In the case of UHPC mixtures containing GGBFS, the decrease in compressive strengths followed a similar trend to that of mixtures without GGBFS (FIG. 8). The seven day and 28-day compressive strengths of MC cured specimens were decreased by 6% and 4%, respectively when LP dosage was increased to 20%. The seven day and 28-day compressive strengths of WB cured specimens decreased by 10%, when LP dosage was increased to 20%. The greatest 28-day compressive strength, which reached 166 MPa, was observed for the UHPC mixture with GGBFS and without LP under the WB curing regimen. Among the LP replacement dosages, 10% LP replacement showed the greatest 28-day compressive strength of 162 MPa under the WB curing regimen. The decrease in compressive strength can be attributed to the increase in LP dosage, which leads to a reduction in the volume of cement. When incorporating LP into cementitious substances, the decrease in compressive strength arises from various physical mechanisms, including the dilution effect and filler effect. It is also significant to acknowledge that LP does not exhibit pozzolanic characteristics, which results in the absence of additional C—S—H gel formation. Consequently, increasing the LP content affecting the overall mechanical strength of UHPC.

Also, UHPC mixture without GGBFS performed better as compared to UHPC with GGBFS in both MC and WB curing regimens after seven and 28-days (FIG. 8). This is because, UHPC with GGBFS has lower content of cement as compared to UHPC without GGBFS which leads to greater dilution effect when cement is further replaced with LP. Reducing the binder content in UHPC can delay its peak hydration time. Decreasing the binder quantity may adversely affect cement hydration. This suggests that a volume decrease in binder content causes a dilution effect, which impacts both the availability of water and the space required for effective hydration.

The Bonferroni-Holm pairwise comparison test, which provides pairwise comparisons of the means of different groups, was conducted to determine significant differences between the mean compressive strengths of 0% and 10% LP P replacement for UHPC mixtures with and without GGBFS, considering 28-day compressive strength under MC and WB curing regimens (Table 5). From Table 5, it is evident that with 95% confidence, there is not statistically significant difference in compressive strengths between UHPC mixture with 0% LP and with 10% LP replacement, whether they contain GGBFS or not. Adding

TABLE 5
Bonfferoni-Holm comparison significance test
for UHPC mixtures with and without GGBFS.

| | | | | | Bonfferoni- |
|---|---|---|---|---|---|
| | | | | | Holm pairwise |
| | | | | | comparison |
| | LP % | | Curing | | test |
| UHPC mixture | comparison | | regimen | P-value | (Significance) |
| With GGBFS | 0% | 10% | MC | 0.52778854 | No |
| | 0% | 10% | WB | 0.12615471 | No |
| Without GGBFS | 0% | 10% | MC | 0.20817027 | No |
| | 0% | 10% | WB | 0.10088269 | No |

10% LP as a cement replacement showed little to no effect on early mechanical strength. It is also evident from FIG. 8 that UHPC mixtures produced with LP replacements greater than 10% were also exhibited UHPC-class compressive strengths (>120 MPa). Further, to attain a compressive strength of 120 MPa, the need to cure the samples at elevated temperature for 28-day is not necessary since the compressive strength of 120 MPa can be achieved in seven days of WB curing.

### Flexural Strength

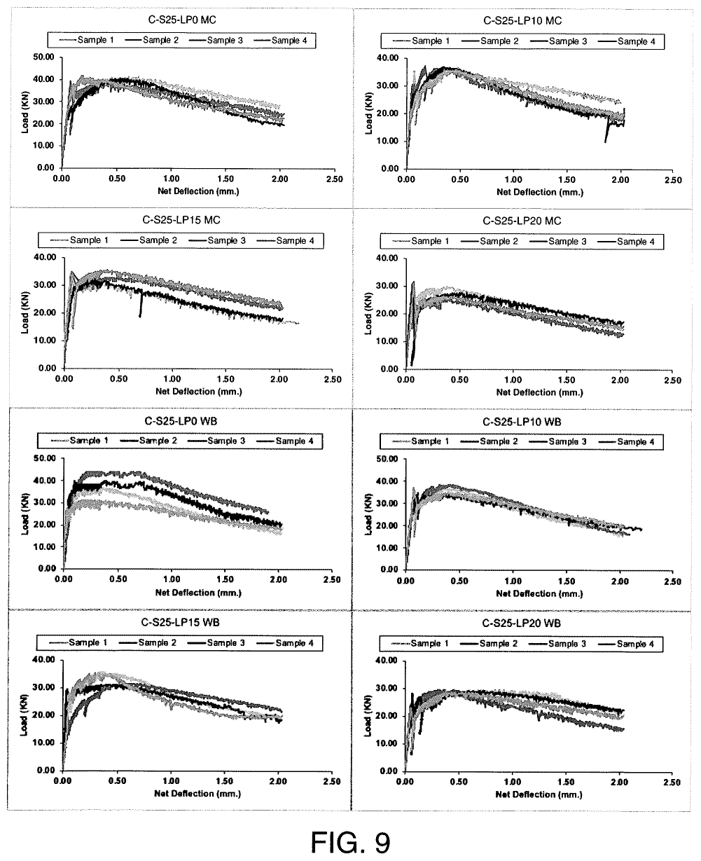

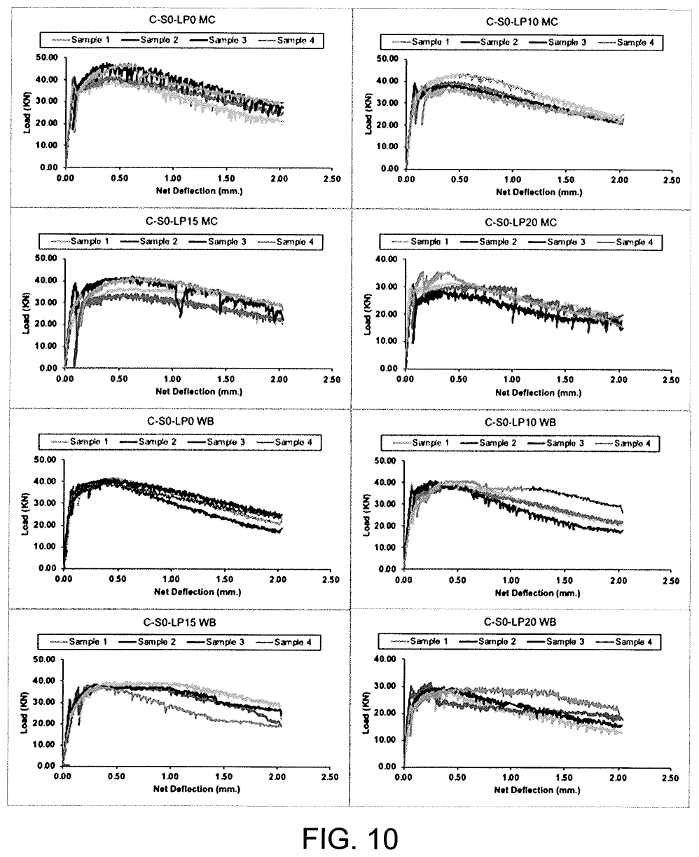

The key value of UHPC is not only its high compressive strength, but also its flexural performance. UHPC generally has superior flexural strength because of the addition of fibers and the strong bonding between the fibers and the matrix. The load-displacement curves of UHPC mixtures incorporated with LP ranging from 0%-20% under 28-days of MC and WB curing regimens are shown in FIG. 9 (with GGBFS) and FIG. 10 (without GGBFS).

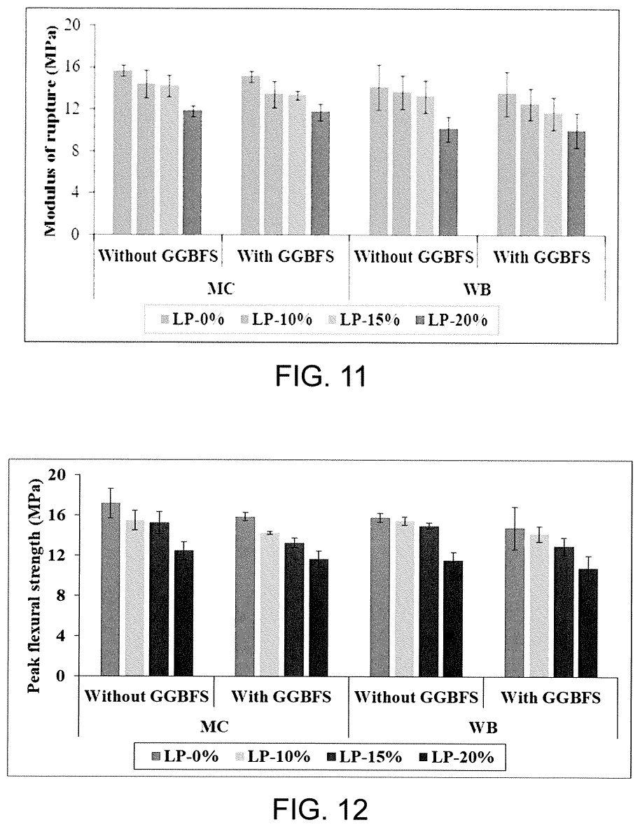

Modulus of rupture: FIG. 11 shows the first cracking flexural strengths (MOR) of UHPC mixtures. It is evident that MOR decreased with the increase of LP % as a replacement of cement. The 28-day MOR values of MC and WB cured specimens decreased by 20% and 25% when LP dosage was increased to 20% for UHPC mixture with GGBFS. Similarly, 28-day MOR values of MC and WB cured specimens decreased by 30% when LP dosage was increased to 20% for UHPC mixture without GGBFS. The maximum MOR among the LP replacement dosages was observed for 10%, 14.4 and 13.4 MPa for with and without GGBFS UHPC mixtures respectively, under MC curing regimen. MOR values followed the similar trend as observed in compressive strengths under MC and WB curing. When LP was used to replace cement, the decrease in the amount of cementitious materials in the UHPC mixture (dilution effect) resulted in a corresponding decrease in the flexural strength of UHPC mixtures.

Peak flexural strength: FIG. 12 depicts the peak strengths of UHPC mixtures with varying LP dosage, both with and without GGBFS, under MC and WB curing regimens. It is important to observe the peak strength in the case of UHPC because the addition of fibers can help in achieving the strength even after the development of first crack. Steel fibers can effectively prevent the development and growth of cracks through its bridging and crack-restricting mechanisms further increasing the load carrying capacity even after first cracking. A decrease in peak strength values was observed with an increase in LP dosage replacing cement up to 20%. The 28-day peak flexural strengths of both MC and WB cured specimens decreased by 26.5% when LP dosage was increased to 20% for UHPC with GGBFS. Similarly, 28-day peak flexural strength of MC and WB cured specimens decreased by 26% and 27% when LP dosage was increased to 20% for C-S0-LP, respectively. The maximum peak strength among the LP dosages was observed for 10%, 14.3, and 15.5 MPa for UHPC mixtures with and without GGBFS, respectively, under MC curing regimen.

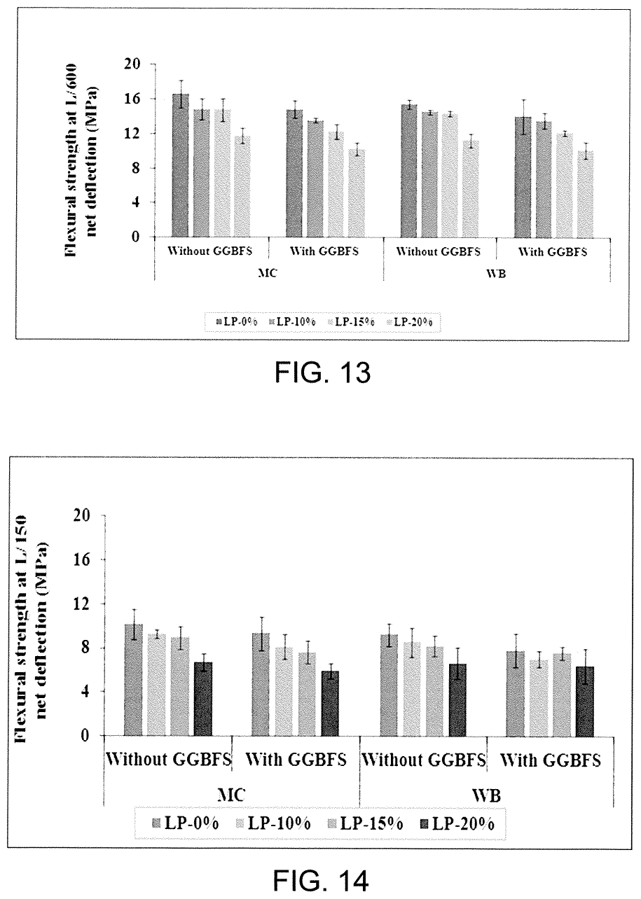

Residual flexural strength: Furthermore, the residual flexural strengths of UHPC mixtures, both with and without GGBFS, were calculated at varying LP dosages and are depicted in FIGS. 13 and 14 at deflections L/600 and L/150, respectively.

The residual strength at net deflections of L/600 and L/150 characterizes the residual capacity after crack formation. The residual strength at L/600 (FIG. 13) was decreased for UHPC with GGBFS when LP dosage was increased up to 20% by 31% and 28% under MC and WB curing regimen, respectively. For UHPC mixtures with no GGBFS cured under MC and WB regimens, the residual strength at L/600 was decreased by 26.5%.

In the case of UHPC mixtures with GGBFS cured under MC and WB regimen, the residual strength at L/150 net deflection was decreased by 36% and 17% when the LP dosage was increased up to 20% (FIG. 14). The residual strength at L/150 net deflection for UHPC mixtures with no GGBFS, cured under MC and WB regimens was decreased by 33% and 28%, respectively, when LP dosage was increased to 20%.

Effect of WB curing regimen on flexural performance: It can be observed from the FIGS. 11 to 14 that the MOR values, peak flexural strengths, and residual flexural strength of WB cured. The adverse effect of curing on flexural strength is more pronounced as larger sized specimens are more susceptible to steep temperature gradients during heat curing, as reported by. The addition of silica fume may induce more micro-shrinkage cracking as a result of which curing has a greater effect on flexural strength than on compressive strength.

Additionally, it can be observed that for all the LP dosages, the UHPC mixtures with GGBFS produced similar or lower flexural strength compared to UHPC mixtures without GGBFS (FIG. 11-FIG. 14). In addition to the dilution effect, reducing the cement content in UHPC results in fewer hydration products, diminishing the chemical influence of the binder materials. Although UHPC with reduced cement content shows lower porosity compared to traditional UHPC, the decrease in hydration product formation is likely responsible for the observed decline in both flexural and tensile properties.

In conclusion, the addition of LP to UHPC reduces its flexural strength. However, the fibers in UHPC can bridge the cracks and carry the applied load further.

### Toughness

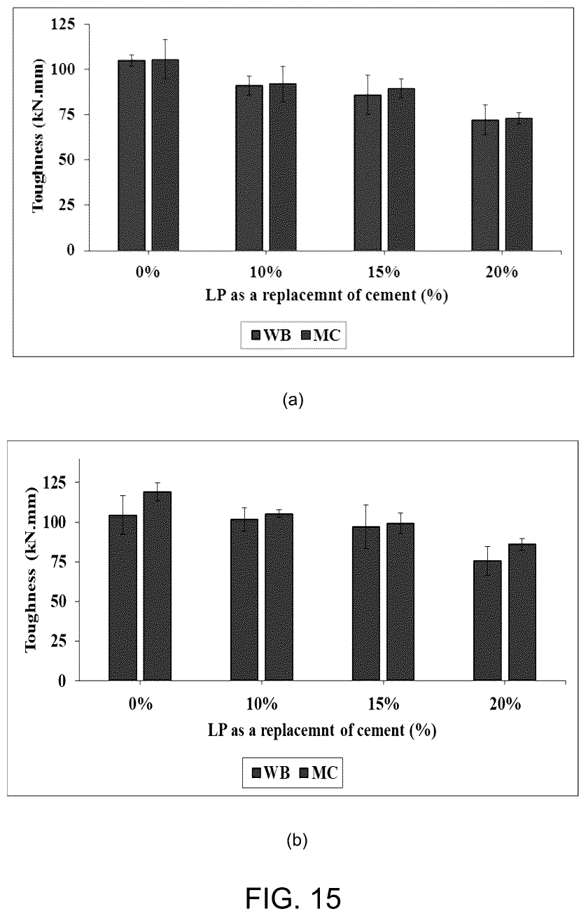

The area under load versus net deflection curve up to net deflection of L/150 was determined to calculate the toughness of UHPC. FIGS. 15 (a) and (b) shows the average toughness values for UHPC mixtures with and without GGBFS, with LP dosage varying from 0-20%. As can be seen from FIGS. 15 (a) and (b), the toughness of UHPC mixtures cured under MC and WB regimens with GGBFS decreased by 30% and 31%, respectively as LP dosage was increased 20%. Similarly, for UHPC without GGBFS cured under MC and WB, the toughness was decreased by 28%. UHPC specimens cured under MC regimen exhibited greater toughness as compared to those cured under WB regimen. The greatest toughness values were observed in UHPC mixtures containing LP replacing 10% of cement and these values for UHPC mixtures with and without GGBFS were 106 and 118 kN·mm, respectively. Overall, the results suggest that the use of LP as a replacement for cement beyond 10% in UHPC can have a negative impact on flexural toughness as seen in case of compressive and flexural strengths.

### Effect of LP Content on Autogenous and Drying Shrinkage of UHPC

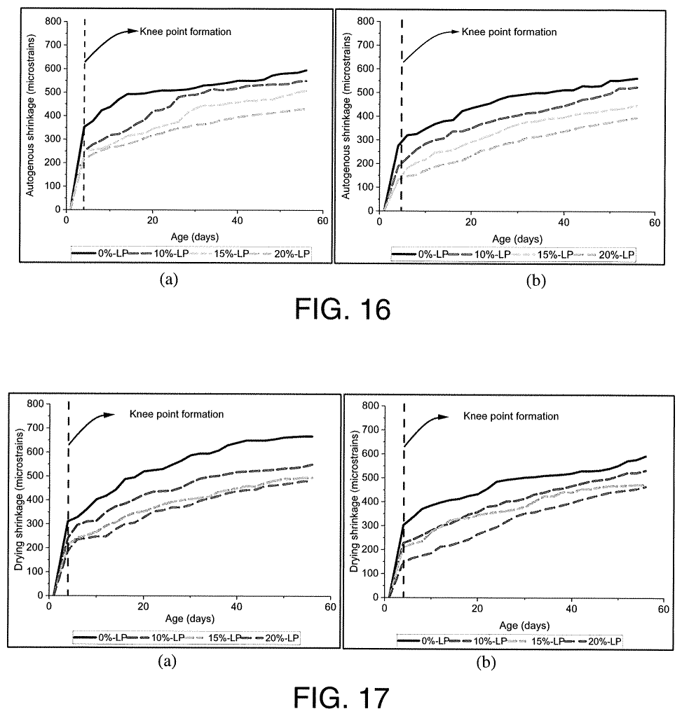

Two potential forms of shrinkage are drying shrinkage that occurs due to moisture loss from the UHPC, while autogenous shrinkage results from a volume reduction as the cementitious materials undergo hydration. Both drying and autogenous shrinkage were measured up to 56 days. FIG. 16 and FIG. 17 shows the average autogenous shrinkage and drying shrinkage for UHPC mixtures with and without GGBFS. From FIGS. 16 (a) and (b), there was 31% and 40% reduction in autogenous shrinkage at 28 days for the UHPC with and without GGBFS UHPC mixture, respectively with the 20% LP dosage. At 56 days, the autogenous shrinkage was decreased by 28% and 30% for with and without GGBFS UHPC mixture, respectively with 20% LP dosage. When cement is replaced with LP the dormant period is shortened due to the filler effect and the hydration of cement is accelerated which eventually reduced the autogenous shrinkage.

Similar trend was observed in case of drying shrinkage (FIGS. 17 a and b). At 28 days, the drying shrinkage was decreased by 35% and 32% for UHPC mixtures with and without GGBFS, respectively with 20% LP dosage. Similarly, at 56 days, the drying shrinkage was decreased by 28% and 22% for UHPC mixtures with and without, respectively with 20% LP dosage. It is evident that with the increase in LP replacement percentage, both autogenous and drying shrinkages were decreased.

The reduction in overall shrinkage due to addition of LP can be attributed to the formation of the knee point at which the rate of increase in shrinkage begins to suddenly decelerate. The development of a stress-resistant microstructure at the knee point prompts the cessation of early-age shrinkage, and the earlier this point forms, the shorter the duration of rapid shrinkage, leading to a decrease in both initial and final shrinkage values. As the LP dosage increases from 0% to 20%, the formation of the knee point occurs earlier (FIGS. 16 and 17).

This underscores the significance of not just minimizing cement content but also ensuring the timely establishment of the knee point in influencing overall shrinkage values. Moreover, reduced overall shrinkage due to inclusion of 20% LP is a result of the reduction in absolute water content associated with higher levels of limestone powder. Consequently, this contributes to the enhancement of volumetric stability in UHPC.

Based on FIGS. 16 and 17, it is evident that while increasing the dosage of LP led to a reduction in shrinkage, the autogenous and drying shrinkage values were still higher in UHPC mixtures containing GGBFS. The addition of GGBFS significantly influenced the increase in shrinkage, mainly due to its ability to refine the pore structure of the concrete. This refined pore structure caused more pronounced shrinkage effects, as indicated by the higher shrinkage values in the mixtures with GGBFS.

### Sustainability

UHPC has the ability to achieve about 4-8 times strength compared to normal concrete while using about 2-4 times more cement per unit volume. In addition, its exceptional durability stands out as a key factor contributing to its longevity. For example, as the need to renovate or refit old concrete structures increases, the use of UHPC in the form of thin liners (typically 30-40 mm thick) will provide significant improvements to the integrity of the concrete and function of the structure. This can be achieved without placing a noticeable load on the weight of the structure. Furthermore, by increasing the thickness of the UHPC by a few millimeters, the service life of the concrete structure can be extended by decades. Such measures enhance the sustainability of the construction. Widespread adoption of UHPC for repair and restoration purposes has the potential to reduce portland cement consumption associated with the construction of new structures. In addition, it can play an important role in reducing environmental problems such as the generation of fine dust and waste during the demolition of structures.

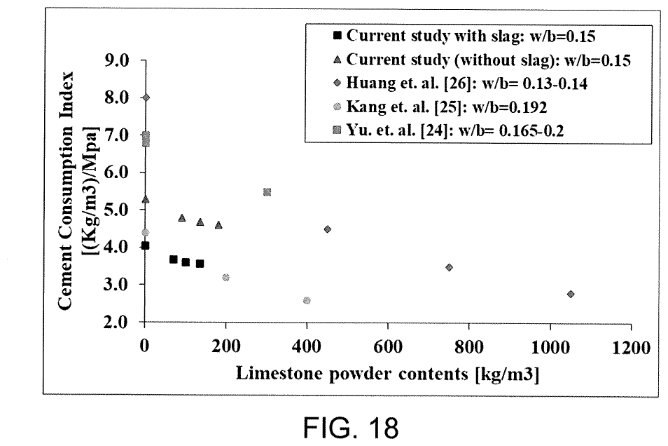

The addition of LP can reduce the amount of unhydrated cement which is not being used in its original form. Hence, LP can be a useful substitute to reduce the cement in UHPC and to improve sustainability. To evaluate this, CCI which is used to access the efficiency of cement consumed in self-compacting concrete serves as a crucial metric for gauging the effectiveness of cement utilization in the given context. CCI implies the amount of cement content (in kg/m³) needed to achieve a unit compressive strength of 1 MPa. A lower CCI value indicates a more efficient consumption of cement for producing a specific volume of concrete, as a smaller quantity of cement is incorporated in the concrete to attain the desired strength level. FIG. 18 shows the CCI as a function of LP content in various formulations of UHPC reported by others compared with the UHPC formulations developed in the current study. It can be observed that CCI proportionally decreases with the increase in LP content (FIG. 18). In the UHPC mixtures presented in the current study, for instance, the UHPC mixture with GGBFS requires 4 kg of cement to achieve 1 MPa strength when no LP is used to replace cement. Similarly, for the UHPC mixture without GGBFS, 5.3 kg of cement is needed to attain 1 MPa strength when no LP is used as a replacement. When LP is used as replacement of cement in UHPC mixture with GGBFS, the amount of cement used was 10% less as compared to UHPC mixture with GGBFS when no LP is used as cement replacement. It can be noted that this decrease in cement content is calculated after 25% of cement has been replaced with GGBFS.

Similarly, for UHPC mixture without GGBFS, the amount of cement used was 13% less as compared to UHPC mixture with and without GGBFS when no LP is used as cement replacement. As the LP replacement is increased, the CCI ratio decreases for both types of UHPC mixtures. This study shows that using LP to replace cement in UHPC can reduce the amount of cement needed to achieve the desired strength, even though the mechanical strength may be affected marginally due to the cement dilution effect, as discussed in previous sections. Therefore, decreasing the amount of unhydrated cement in low w/cm ratio concretes by replacing it with LP is a rational approach from both environmental and economic perspectives.

Another sustainable way to produce concrete is to reduce the CCR by using SCMs effectively. According to UN Climate Technology Centre and Network, the average CCR is about 0.81. This ratio is with the adjustment comprising gypsum and added substances such as GGBFS, FA, and natural pozzolans. Table 6 shows the various CCR values for all the mixtures used in this study.

The lowest CCR is for the UHPC mixture with GGBFS. In comparison with UHPC mixture without GGBFS, the CCR of UHPC with GGBFS was 25% lower. This is approximately 40% less in comparison with the average global CCR value. Similarly, for UHPC mixture without GGBFS, after 20% cement replacement of cement with LP, the CCR was 0.67, which is approximately 20% lower than the global average CCR. Use of 20% LP as a replacement of cement with the incorporation of GGBFS can help in producing UHPC with improved workability, comparable mechanical performance and reduced shrinkage besides reducing the cement content by half.

Therefore, incorporation of various SCM's with LP can be used to produce eco-friendly and cost-effective UHPC.

TABLE 6
CCR values for all the UHPC mixtures
presented in the current study.

| UHPC mixture | CCR values |
|---|---|
| C-S25-LP0 | 0.63 |
| C-S25-LP10 | 0.57 |
| C-S25-LP15 | 0.54 |
| C-S25-LP20 | 0.50 |
| C-LP0 | 0.84 |
| C-LP10 | 0.76 |
| C-LP15 | 0.71 |
| C-LP20 | 0.67 |

### CONCLUSIONS

As the limestone powder (LP) content increased, workability in UHPC showed improvement, reaching a 30% increase for mixtures with GGBFS and a 33% increase for those without GGBFS at a 20% LP dosage.

The compressive strength of UHPC mixtures decreased with an increase in LP dosage up to 20%. However, no significant reduction in compressive strengths of UHPC mixtures was observed at a 10% LP dosage. Overall, a 20% LP replacement can produce UHPC-class compressive strengths under both standard and accelerated curing regimens.

LP replacement negatively affected the flexural performance of UHPC, as evidenced by the decline in the 28-day modulus of rupture, peak flexural strength, and residual strength, all showing a consistent trend with increased LP dosage.

The flexural strengths of WB cured specimens were lower than those cured under MC regimen.

Incorporation of LP led to a reduction in both autogenous and drying shrinkage of UHPC mixtures. Using 20% LP, there was 28% and 30% reduction in autogenous shrinkage in UHPC mixtures with and without GGBFS, respectively after 56 days. Similarly, 29% and 21.5% reduction in drying shrinkage was observed in UHPC mixtures with and without GGBFS, respectively after 56 days.

The study evaluated the cement composition index (CCI) to assess the efficiency of cement consumption. The data showed that CCI decreased as LP content increased. For UHPC mixture with GGBFS, 20% LP replacement resulted in a 10% decrease in CCI compared to UHPC mixture without GGBFS.

Cement-to-clinker ratios (CCR) were calculated for UHPC mixtures. The greatest reduction of CCR value was observed in UHPC mixture with GGBFS. This was 40% lower than the global average value of 0.81.

### Additional Examples

### Materials and Experimental Methods

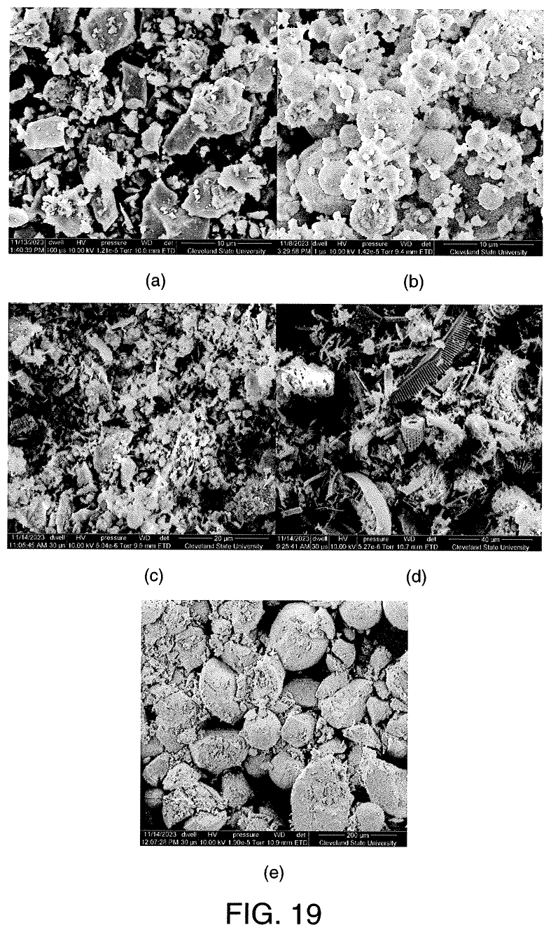

Materials: In this research, Type 1 L portland limestone cement (PLC) was utilized. It possesses a specific gravity of 3.15 and a Blaine specific surface area of 342,395 in²/lb (487 m²/kg). Class F fly ash with particle sizes ranging between 393.7-3937 μinch (10-100 μm) and a specific gravity of 2.48 and silica fume with a specific gravity of 2.2 were used as SCMs in the control mixture. MK and DE whose specific gravity were 2.5 and 2.2 respectively were considered as alternatives for fly ash and silica fume in this study. Table 7 presents the physical and chemical properties of these materials. In addition, the scanning electron microscope (SEM) images of the five precursors: cement, fly ash, metakaolin, diatomaceous earth, condensed silica fume are also shown in FIG. 19.

Local sand conforming to ASTM C33 while specific gravity and absorption values of the sand were determined according to ASTM C128 and were found to be 2.78% and 2.35%, respectively. For this work, sand was sieved through ASTM No. 4 (0.0029-0.1870 inch or 0.075-4.75 mm) sieve and oven dried at (110° C.) 230° F. to achieve a 0% moisture content.

To enhance the tensile ductility of the UHPC, straight steel fibers measuring 0.5 inches (13 mm) in length, with an aspect ratio of 65, were used in this research. To attain the desired workability, a commercially available polycarboxylate-based high-range water-reducing admixture (HRWRA) was added into the mixtures.

TABLE 7
Chemical composition and physical properties of cementitious
materials (Properties in Tables may be considered as also
disclosing +/−30%, 20%, 10%, or 5% of the specified value)

| | Materials | | | | |
|---|---|---|---|---|---|
| | | | | | Diato- |
| | Cement | Class F | Silica | | maceous |
| | Type IL | Fly Ash | Fume | Metakaolin | Earth |
| Chemical | | | | | |
| compounds | | | | | |
| CaO | 63.1 | 3 | 0.7785 | — | 1.24 |
| SiO₂ | 18.9 | 45.8 | 83.85 | 49.35 | 82.16 |
| Al₂O₃ | 4.4 | 22.8 | 0.56 | 45.03 | 4.85 |
| Fe₂O₃ | 2.5 | 22.6 | 3.63 | 0.5 | 1.66 |
| MgO | 1.6 | 0.8 | 4.74 | — | 0.45 |
| Na₂O | 0.34 | 0.47 | — | — | 0.54 |
| K₂O | — | 1.76 | 1.12 | 0.42 | 0.72 |
| TiO₂ | — | — | — | 2.19 | 0.24 |
| MnO | — | — | 0.3 | — | 0.01 |
| P₂O₅ | — | — | — | 0.097 | 0.06 |
| SrO | — | — | 0.02 | 0.02 | 0.02 |
| Br | — | — | 0.74 | 0.7 | |
| BaO | — | — | | — | 0.03 |
| SO₃ | 3 | 0.86 | 0.06 | 0.05 | — |
| Cr₂O₃ | — | — | 0.05 | — | 0.01 |
| Limestone | 12.1 | — | — | — | — |
| CO₂ | 5.4 | — | — | — | — |
| CaCO₃ | 91 | — | — | — | — |
| Loss of | 5.4 | 1.9 | 2.96 | 0.83 | 7.41 |
| Ignition | | | | | |
| Physical | | | | | |
| Properties | | | | | |
| Specific | 3.15 | 2.48 | 2.2 | 2.5 | 2.2 |
| Gravity | | | | | |
| (g/cm³) | | | | | |
| Specific | 487 | — | 25,000 | 22,000 | — |
| Surface area | | | | | |
| (m²/kg) | | | | | |
| Mean | — | 10-100 | 1 | 1.3 | — |
| Particle | | | | | |
| Size (μm) | | | | | |
| Autoclave | 0.022 | 0.02 | — | — | — |
| Expansion | | | | | |
| (%) | | | | | |

### Development of UHPC Mixtures:

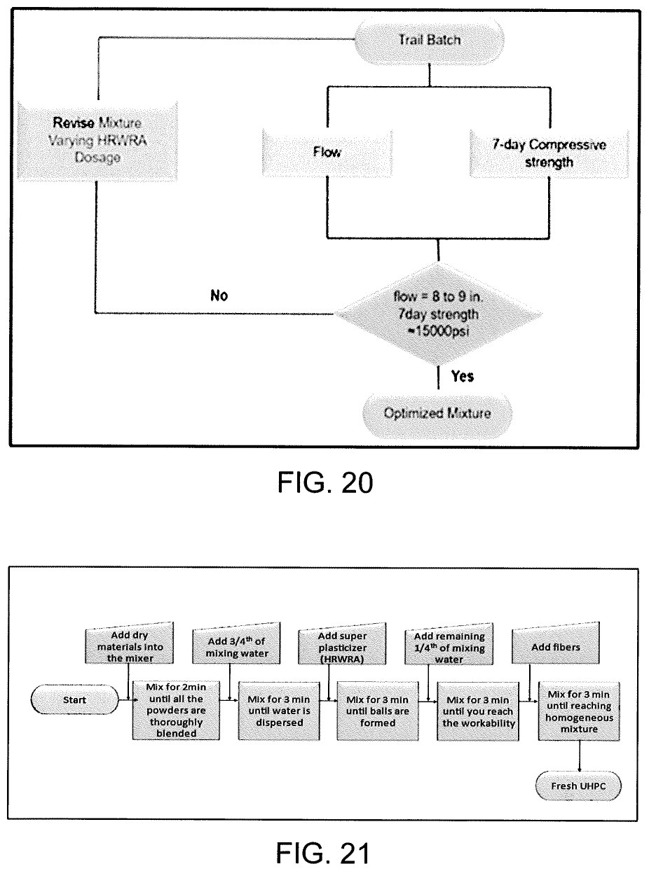

UHPC mixtures: In this research, the control UHPC mixture was developed using cement, silica fume, and fly ash as cementitious materials, several trial batches were made to optimize the silica fume/fly ash ratio that would produce UHPC class material as defined by ASTM C1856. In these trials, different water-to-cementitious ratios (w/cm) and HRWRA dosages were used for a specific silica fume-to-fly ash ratio. Preliminary tests such as workability and compressive strength were performed for each trial mixture and the optimum w/cm, HRWRA dosage, and silica fume/fly ash ratios are found to be 0.2, seven gal/yd³ (34.65 L/m³), and one respectively. Based on these results, control UHPC mixture with 16% SCM with eight percent silica fume and eight percent fly ash by mass of cementitious materials, w/cm ratio of 0.2, 1.52% by total volume of steel fibers, and seven gal/yd³ (34.65 L/m³) was selected for future use in this research. FIG. 20 depicts the optimization process.

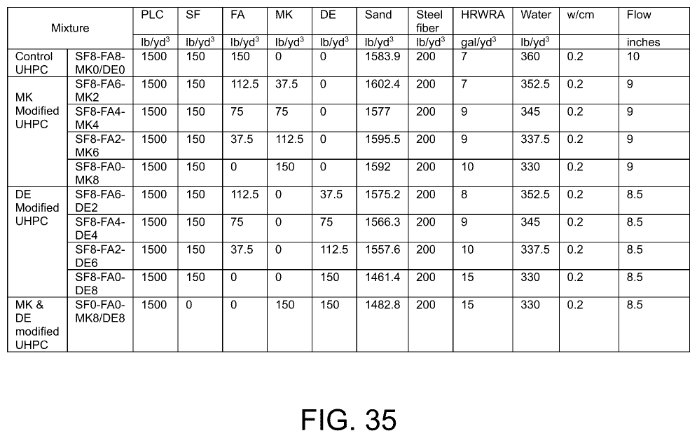

FIG. 35 presents the 10 UHPC mixture proportions developed in this study. Given the primary objective of substituting fly ash and silica fume with alternative SCMs, the control UHPC mixture with FA and SF are the SCMs were further modified. MK and DE were employed to replace FA incrementally, up to 100% in 25% increments, without changing the silica fume content. This process aimed to identify the optimal level of fly ash replacement. Subsequently, once the ultimate fly ash replacement levels with both MK and DE were established, the silica fume content was also modified utilizing MK and DE.

Mixtures belonging to each category were assigned specific designation based on their composition. To interpret the mixture designation, the letters indicate the SCM type in the mixture, FA for fly ash, SF for silica fume, MK for metakaolin, and DE for diatomaceous earth. The number following each letter indicates the percentage of the SCM in the mixture. For instance, the control mixture SF8-FA8-MK/DEO contained 8% of SF and 8% of FA out of total cementitious materials and in the case of mixture SF8-FA6-MK2, 25% of fly ash was replaced with MK, resulting a mixture that contains 6% and 2% of fly ash and MK out of total cementitious materials content, respectively.

To achieve a homogenies UHPC mixture with uniform dispersion of fibers, a meticulous step-by-step mixing process is employed, as illustrated in FIG. 21. The procedure commences with a two-minute mixing of the dry components, followed by the gradual addition of two-thirds of the required water, mixed for an additional three minutes. Subsequently, HRWRA and the remaining portion of water were introduced, and the mixed for another three minutes. At the end, steel fibers were added into the UHPC mixture during the mixing process. The total mixing time varied from 15-20 min. A vertical shaft mixer with a 38 rpm for two minutes paddle speed was used to mix the constituents of UHPC. The fresh UHPC was then poured into molds and covered with plastic sheets to prevent moisture loss. They were then left at room temperature for 24 hours. Following this period, the specimens were removed from the molds and subjected to designated curing conditions.

Specimen Preparation: Each batch of UHPC produced was used to cast 2-inch (50 mm) and 4-inch (100 mm) cubes for compression testing, 3×4×16-inch (75×100×400 mm) beams for flexure testing, and 4×8-inch (100×200 mm) cylinders for split tensile testing and modulus of elasticity. Cylinders were filled in three layers, each rodded 25 times. Beams were filled in two layers, each rodded 32 times (2 strokes for every inch of cylinder) and tapped with a mallet on all sides of the mold to ensure proper consolidation.

Curing regimens: Specimens were cured under the following two curing regimens to investigate the effect of curing temperature on mechanical properties:

| Curing | |
|---|---|
| condition | Specification |
| Moist | Air cured in the molds for 24 hours. After demolding, the |
| curing | specimens were placed in a moist room with ~100% |
| (MC) | relative humidity and temperature 23.5 ± 1.5° C. (74 ± 3° F.) |
| | until the day of testing. |
| Warm | Air cured in the molds for 24 hours. After demolding, |
| bath | specimens were cured in a water bath at 90° C. (194° F.) |
| (WB) | until the time of testing. This curing method simulated the |
| | steam curing method employed in precast plants. |

### Experimental Methods

Compressive strength testing: ASTM C109 provides standardized procedures and requirements for conducting this test, ensuring consistent and reliable measurements of compressive strength for hydraulic cement mortars. In this study, four 2-inch (50 mm) cube specimens and two 4-inch (100 mm) cube specimens cured under MC and WB regimens were tested at each age (three, seven, 28, 56, and 91 days), and average compressive strength was reported.

Flexural strength testing: 3×4×16-inch (75×100×400 mm) prismatic specimens were cast from each batch of UHPC and cured under MC and WB regimens. Flexural strength tests were conducted at ages seven and 28 days in accordance with ASTM C1609. Three prismatic specimens were tested at each age. Strengths and deflections at first peak load and peak load, residual strengths at net deflections of span/600 and span/150 and toughness, which is the area under load vs net deflection curve 0 to span/150 were determined.

Split tensile strength testing: 4×8-inch (100×200 mm) cylinder specimens were cast from each batch and moist cured until 28 days and were tested for split tensile strength according to ASTM C496. Two cylinder specimens from each batch were tested and average split tensile strength was reported.

Modulus of elasticity testing: ASTM C469 provides a standardized and reliable method for evaluating the modulus of elasticity and Poisson's ratio of concrete. In the test, 4×8-inch (100×200 mm) cylinder specimens cured for 28 days in MC regimen were subjected to axial compressive loading to determine the modulus of elasticity and Poission's ratio.

Rheology tests on cement paste: Rheology tests on aggregate-free cement pastes were performed to assess viscosity, shear stress, shear thickening, and shear thinning behavior in UHPC mixtures.

Scanning electron microscopy: SEM imaging was systematically carried out on dry cementitious powders. The primary objective was to meticulously explore and analyze the distinct microstructure inherent to each individual material. This detailed examination, provided valuable insights into the fine-scale features such as particle shape and structure of the cementitious powders under consideration.

### Results and Discussions

### Rheology of Pastes Containing Different Cementitious Materials:

Optimization of UHPC mixtures: The control mixture served as the baseline mixture. Further optimization involved substituting fly ash with MK and DE, and also replacing SF with MK in the DE modified UHPC mixture:

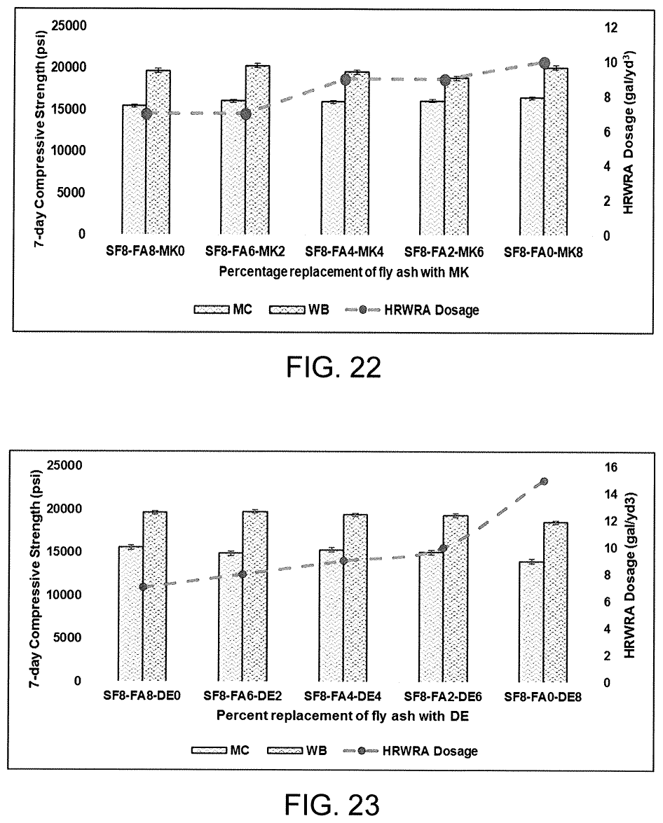

Metakaolin as SCM to replace fly ash: This optimization process focused on reducing the fly ash content by replacing it with MK. Fly ash was replaced by MK with replacement levels ranging from 0% to 100% in the increments of 25% by mass of fly ash. As the fly ash content decreased and the MK content increased, a reduction in the flow of UHPC was observed (FIG. 22). Various trials were conducted to determine the optimal dosage of HRWRA needed to achieve the target static flow of 8-9 inches (203.2 mm to 228.6 mm). Once the HRWRA dosage was determined, 2-inch (50 mm) cube specimens cured under both MC and WB regimens were tested at seven days to assess the compressive strength of MK-modified UHPC mixtures. FIG. 22 depicts the impact of MK content on the seven-day compressive strength of UHPC mixtures cured under MC and WB regimens.

The results clearly indicate an increase in the dosage of HRWRA as MK dosage increased from 0% to 100%, replacing fly ash. This observation aligns with the evidence that incorporating MK and silica fume into the mix leads to a reduction in concrete workability. This trend may be attributed to the larger surface area of MK particles compared to those of fly ash particles. SEM imaging (FIG. 19) on raw MK powder reveals that particle shape can influence the water demand of a material. Finer and more irregularly shaped particles, as observed in MK (FIG. 19(c)), may contribute to a higher water demand compared to the coarser and more spherical particles typically found in fly ash (FIG. 19(b)). Furthermore, FIG. 22 illustrates that the seven-day compressive strength of all the mixtures gradually increased with the increase in MK content. The increase in strength due to increase in MK is probably due to the fact that MK typically has finer particles and a more reactive surface area compared to fly ash. This finer particle size allows for better packing within the concrete mixture, leading to improved compaction and reduced porosity. Additionally, the amorphous nature of MK particles facilitates their reactivity, promoting the formation of additional cementitious phases and enhancing strength development. Specimens produced from the SF8-FA0-MK8 mixture, cured under both MC and WB regimens demonstrated compressive strength increases of 5.2% and 2.9%, respectively, compared to those from the control mixture. Based on the results, mixture SF8-FA0-MK8, which represents a 100% replacement of FA with MK designated as MK modified UHPC, successfully met all the required properties for UHPC class material. As a result, this mixture has been selected as the final mixture for further testing and development.

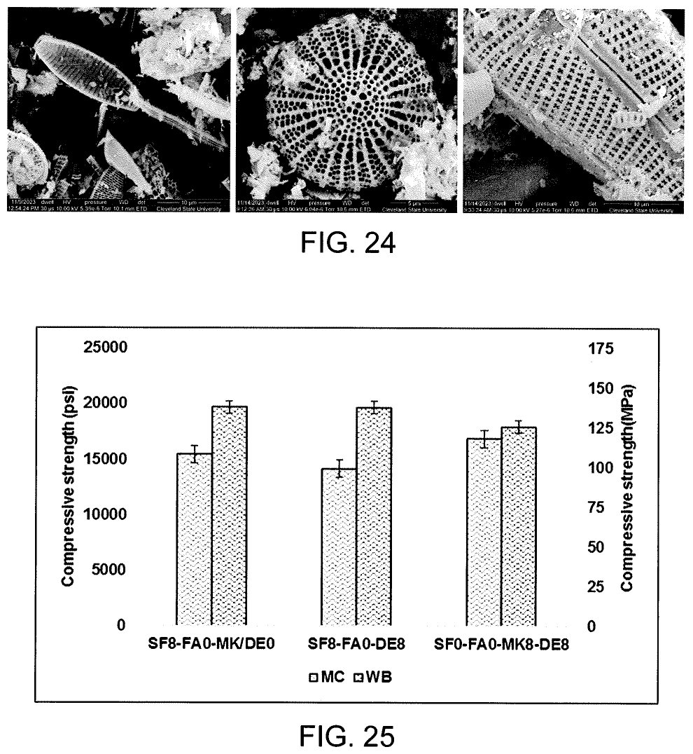

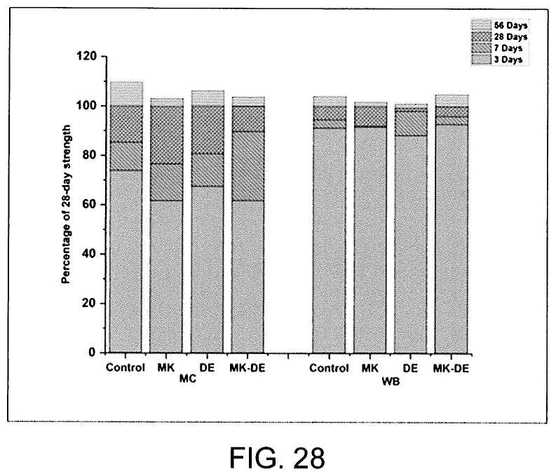

Diatomaceous Earth as SCM to replace fly ash: FA was replaced by DE in a similar manner as in the case of MK replacement. A decrease in the flow was observed as the DE content increased (FIG. 23), which resulted in an increase in HRWRA dosage. The increased water demand due to increased DE content can be attributed to the water-absorbing characteristics of DE and its distinct porous microstructure (FIG. 24). Additionally, the higher quantity of finer DE particles required more water to become wet when compared to the fly ash particles. It is also evident from FIG. 28 that the maximum compressive strength was observed in mixtures with 75% replacement level of fly ash with DE in warm bath curing while 100% replacement of FA with DE resulted in a 10% and 5% decrease in compressive strengths of MC and WB cured specimens, respectively when compared to those from control mixture.

Furthermore, it was observed that incorporating DE replacing 25% of FA (SF8-FA2-DE6) resulted in the greatest compressive strength in the WB regimen. However, SF8-FA0-DE8 (100% replacement of FA with DE) also achieved the target workability and compressive strength. Therefore, considering the primary research goal of complete FA replacement, the mixture SF8-FA0-DE8 was selected as the final mixture in this category and has been selected as the final mixture for subsequent testing and development. This mixture was designated as DE modified UHPC.

Metakaolin as SCM to replace silica fume in DE modified UHPC mixture: After developing DE modified UHPC by replacing FA with DE, an attempt has been made to completely eliminate SF along with FA as SF is not only expensive but can also cause health issues. MK was used to replace SF in the DE modified UHPC to produce a new MK-DE mixture formulation (SF0-FA0-MK8-DE8). This formulation exhibited the desired compressive strength and workability. The desired flow of 8 to 9 inches (203 to 229 mm) was achieved without changing the HRWRA dosage that was used for DE modified UHPC mixture.

In the MC regimen, the MK-DE mixture exhibited greater compressive strengths than the control mixture and DE modified mixture by 9% and 17.5%, respectively. However, decrease in compressive strength was observed in MK-DE mixture cured under WB curing regimen when compared to control and DE modified mixtures that contain SF by 8.7% and 9.1%, respectively. This decreased compressive strength in MK-DE mixture when cured under WB curing regimen can be traced back to the accelerated strength development of the control UHPC mixture during WB curing. This is facilitated by the highly reactive pozzolanic properties of SF, which are especially effective at elevated temperatures. The increased temperature hastens the hydration process, with SF particles actively engaging in chemical reactions with portlandite and water. This interaction leads to the formation of extra C—S—H gel through secondary reactions, which is instrumental in densifying the cement matrix and, as a result, boosting compressive strength in mixtures containing SF. The absence of SF in MK-DE mixtures could be the probable reason for lower compressive strength when cured under WB curing regimen.

Based on the results from preliminary investigation as discussed above, four final UHPC mixtures were selected for further investigations: Control, MK-modified UHPC, DE-modified UHPC, and MK-DE-modified UHPC. These formulations were used for further testing, including assessments of compressive strengths up to 56 days, flexural performance, modulus of elasticity, and split tensile strength and were discussed in detail below.

### Compressive Strength:

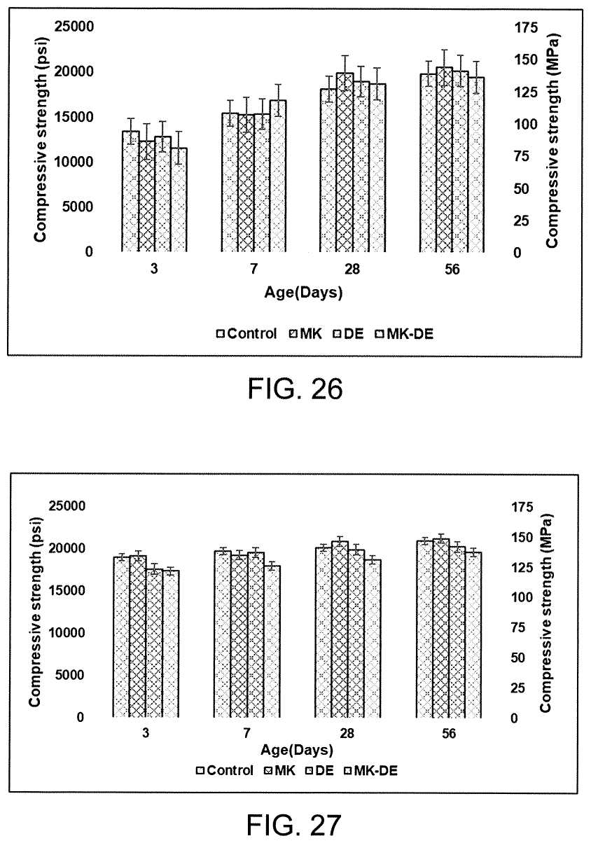

Effect of type of SCM on compressive strength cured under both MC and WB curing regimens: Average compressive strengths at three-, seven-, 28-, and 56-days for six two-inch (50 mm) cubes from each of the four final mixtures cured under both MC and WB regimens are presented in the FIGS. 26 and 27, respectively. In MC curing regimen, the greatest compressive strength of 20,590 psi (142 MPa) was exhibited by MK modified UHPC mixture at 56-days. However, at 28 days, all the three modified UHPC mixtures (MK, DE, and MK-DE) showed greater compressive strengths than the control mixture by 10, 5, and 3.5% respectively. In WB curing regimen, the greatest compressive strength of 21,270 psi (146 MPa) was observed in MK modified UHPC mixture at 56 days. Also, at 28 days, MK modified UHPC mixture exhibited marginally greater compressive strength than the control UHPC mixture by 3.6% whereas DE and MK-DE modified UHPC mixtures exhibited lower compressive strengths than to the control mixture by 1.14% and 7.19%, respectively. This suggests that FA can be completely replaced by MK, leading to enhanced compressive strengths which may be because of the because the size of MK particles is usually under 0.0000787 inches (2 microns), which is significantly smaller than cement particles but larger than the particles of silica fume. The utilization of MK is known to have a substantial impact on the pore structure and calcium hydroxide content of the hardened cement matrix in concrete, owing to its superior purity, pozzolanic reactivity. While DE modified UHPC led to a slight decrease in compressive strength than control UHPC (by 1.14%), it remains a viable replacement for FA. Additionally, the MK-DE modified UHPC, without SF and FA, yielded comparable results to the control UHPC mixture whose results are consistent with.

Effect of age on compressive strength of all the UHPC mixtures cured under both MC and WB curing regimens: The ratios of compressive strength at three, seven, and 56 days with respect to 28-day strength are depicted in FIG. 28. This assumes compressive strength at 28 days is 100% of all the UHPC mixtures cured under both MC and WB curing regimens. The compressive strengths of all the mixtures cured under MC and WB regimens are increasing with age, but the rate of increase is decreasing. The reason was that the reaction rate of portland cement hydration and the number of hydration products, dominated the early strength of concrete mixtures and were gradually retarded and reduced with the increase in time.

When compared to all the mixtures cured under the MC regimen, the control mixture exhibited a remarkable early age compressive strength at three days, achieving 73.9% of its 28-day compressive strength. This was expected because fly ash reacts more quickly than MK and DE. It can also be observed from FIG. 28 that fly ash in the control mixture contributes to later age strength gain more than any other UHPC mixture that contain alternative SCM in this study. This is attributed to the fact that, despite the slow pozzolanic reaction, fly ash can refine the microstructure over the long term. However, MK, DE, MK-DE modified UHPC mixtures showed significant early strength development, reaching approximately 62%, 67%, and 62% of their 28-day compressive strength in three days, respectively. After 28 days, there was a little strength gain (less than 10%) in all the UHPC mixtures.

Coming to the WB regimen, 90% of the 28-day compressive strength was attained at three days in all the mixtures except in DE modified UHPC mixture. DE modified UHPC mixture exhibited 88% of its 28-day strength at three days. The reason for the greater compressive strengths at three days in these mixtures can be attributed to accelerated hydration reactions and reduction in nanoscale pores compared to specimens cured at ambient temperatures and therefore, more hydration products were available to fill up the micropores. Furthermore, it is interesting to note that the 28-day compressive strength of the specimens produced from control UHPC mixture and cured under WB regimen is only 11.3% greater when compared to the MC cured specimens at 28 days, while all the other three modified UHPC mixtures had only 5% greater strengths in WB when compared to MC.

A one-way ANOVA test was performed to assess the statistical significance of the difference in compressive strengths between specimens cured in MC and WB at the age of 56 days. However, in terms of the 56-day compressive strengths, no statistically significant difference (p>0.05) was noted in compressive strength between the two curing regimens for all UHPC mixtures, except in the case of the MK-modified UHPC mixture. This indicates that MK has been demonstrated to alleviate the potential adverse effects of elevated temperatures on the properties of UHPC. The incorporation of MK mitigates any detrimental impacts of heat treatment on the microstructure, eliminating any observable ITZ zones between the aggregate and the matrix. Hence, based on the SCMs utilized in this research, it can be concluded that MK assists in mitigating concerns such as thermal cracking, ensuring the long-term integrity of the concrete.

The convergence in compressive strengths observed in control, DE- and MK-DE modified UHPCs at later ages between WB and MC regimens highlights a key factor in their similarity. The accelerated hydration facilitated by WB curing at early ages is primarily attributed to elevated temperatures. However, as time progresses, the influence of these heightened temperatures gradually diminishes. By the 56^{th} day, UHPC cured under both WB and MC methods has had ample time to attain comparable strengths, as the temperature-related effects become less pronounced.

This finding suggests that, from a sustainability perspective, the water bath curing regimen may not be essential for longer curing ages. The reduced reliance on elevated temperatures in the later stages of curing implies that more environmentally friendly or energy-efficient curing methods could be explored without compromising the ultimate compressive strength of the UHPC. This not only enhances the sustainability profile of the curing process but also opens avenues for the adoption of practices that align with eco-friendly principles in the production of UHPC mixtures. One of the energy-efficient curing methods could be combined curing (combination of short term (three days) of WB and MC until the day of testing). This would help in accelerating the pozzolanic reaction and enhanced microstructure of UHPC in the initial days as UHPC contains a high concentration of cementitious materials and fine aggregates, which require thorough hydration to achieve the desired mechanical properties.

Effect of specimen size on compressive strength of UHPC mixtures cured under both MC and WB curing regimens: As the size of the specimen increases, the compressive strength tends to decrease due to the larger volume being more likely to contain an element of low strength. While there is ample research data available on the effects of specimen size on the compressive strength of conventional concrete, limited data exists for UHPC mixtures. Therefore, the effect of specimen size on compressive strength of UHPC was investigated in this study.

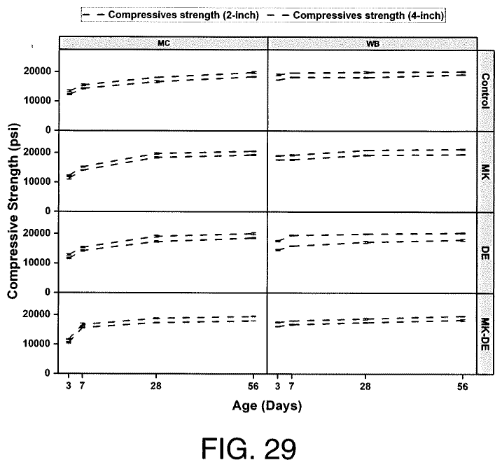

In this study, compressive strengths of 2-inch (50 mm) and 4-inch (100 mm) cube specimens were compared to study the effect of specimen size on UHPC compressive strength (FIG. 29). To enable a straightforward comparison, ratios for the compressive strengths of 2-inch cubes (50 mm) to 4-inch cubes from all the UHPC mixtures were computed and are presented in Table 8. The ratios obtained in this study align with previous research findings.

Statistical analyses have been conducted to assess the impact of specimen size using one-way ANOVA. The results indicate a statistically significant difference (p<0.05) in the compressive strength of UHPC mixtures between 2-inch (50 mm) and 4-inch (100 mm) cube specimens. This difference holds true irrespective of the SCM used, curing regimen, and the testing age.

TABLE 8
50 mm (2 inch) to 100 mm (4 inch) cube compressive
strength ratios for different UHPC mixtures cured
under MC and WB regimen for 3, 7, 28, and 56 days

| Mixture | 3 days | | 7 days | | 28 days | | 56 days | |
|---|---|---|---|---|---|---|---|---|
| Designation | MC | WB | MC | WB | MC | WB | MC | WB |
| Control | 1.09 | 1.10 | 1.08 | 1.08 | 1.09 | 1.09 | 1.09 | 1.10 |
| MK | 1.09 | 1.09 | 1.09 | 1.09 | 1.09 | 1.09 | 1.12 | 1.09 |
| DE | 1.11 | 1.21 | 1.08 | 1.24 | 1.10 | 1.17 | 1.09 | 1.12 |
| MK-DE | 1.10 | 1.08 | 1.09 | 1.09 | 1.09 | 1.08 | 1.09 | 1.09 |

### Flexural Strength

Flexural tests were conducted on 3×4×16-inch (75×100×400 mm) prismatic UHPC specimens. From these tests, various response parameters were obtained and analyzed.

The load-deflection relationship emerged as a critical metric, offering comprehensive insights into both pre- and post-cracking behaviors of UHPC mixtures incorporating alternative SCMs. The average first peak strength (modulus of rupture-MOR), peak strength, toughness, residual strengths at L/600 and L/150, and equivalent flexural strength ratios at L/600 and L/150 of all the UHPC mixtures were calculated and presented in Table 9

TABLE 9
Flexural strength results

| | | First | | | | | | Residual | | Residual | | Equivalent | | Equivalent | |
|---|---|---|---|---|---|---|---|---|---|---|---|---|---|---|---|
| | | peak | | Peak | | | | strength | | strength | | flexural | | flexural | |
| | | strength | | strength | | Toughness | | at L/150 | | at L/600 | | strength at | | strength at | |
| | | (psi) | | (psi) | | at 28 days | | (psi) | | (psi) | | L/150 (%) | | L/600 (%) | |
| | | 7 | 28 | 7 | 28 | (Joules) | | 7 | 28 | 7 | 28 | 7 | 28 | 7 | 28 |
| | | day | day | day | day | L/600 | L/150 | day | day | day | day | day | day | day | day |
| MC | Control | 1460 | 1585 | 1695 | 1740 | 13 | 49.9 | 860 | 1010 | 1545 | 1650 | 72.5 | 81.2 | 82.4 | 85 |
| | MK | 1360 | 1420 | 1765 | 1835 | 13.8 | 49.3 | 1110 | 1265 | 1650 | 1725 | 71.2 | 72.8 | 83.5 | 84.1 |
| | DE | 1225 | 1285 | 1460 | 1605 | 13 | 48.6 | 670 | 930 | 1310 | 1630 | 82.1 | 79.2 | 84.7 | 83.8 |
| | MK-DE | 1350 | 1485 | 1495 | 1680 | 12.4 | 52.5 | 1040 | 1150 | 1630 | 1710 | 84.1 | 86.3 | 90.5 | 92.6 |
| WB | Control | 1390 | 1485 | 1700 | 2145 | 11.9 | 46.3 | 1080 | 1100 | 1475 | 1640 | 75.6 | 63.4 | 83.2 | 67.8 |
| | MK | 1345 | 1695 | 1925 | 2105 | 14.42 | 48.4 | 1115 | 1155 | 1850 | 2045 | 77.5 | 80.3 | 83.4 | 86.8 |
| | DE | 1210 | 1520 | 1735 | 1715 | 10.7 | 39.4 | 600 | 655 | 1230 | 1495 | 69.6 | 66 | 78.7 | 76 |
| | MK-DE | 1320 | 1635 | 1755 | 1890 | 11.9 | 38.4 | 725 | 850 | 1435 | 1475 | 79.5 | 77.2 | 88.7 | 82.5 |

Note:
1 psi = 0.00689476 MPa.

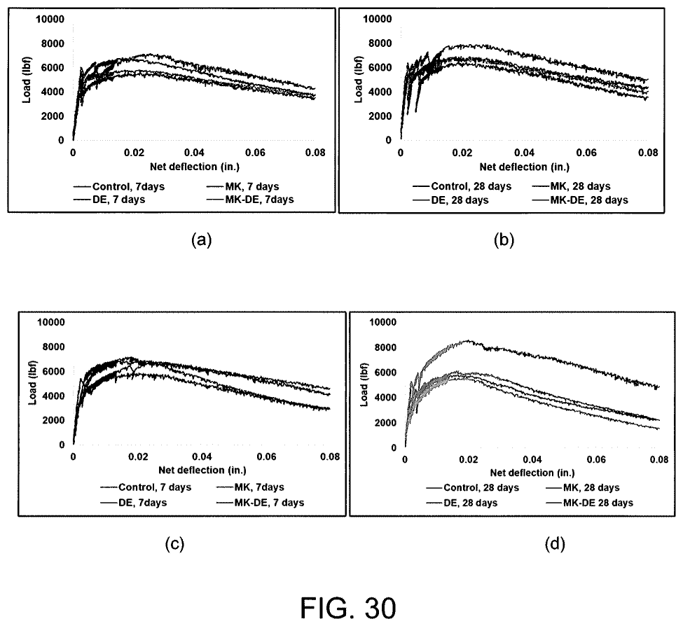

FIG. 30 shows the load-deflection curves for all the UHPC mixtures cured under MC and WB curing regimen tested at seven and 28 days.

Each load-deflection curve initiates with a steep linear segment, signifying prominent initial stiffness. Following this, the curve demonstrates nonlinearity until encountering the first cracking point, signifying a decline in initial stiffness due to the formation of internal microcracks. At the first cracking point, the load-deflection curve experienced a drop in all the mixtures, with a more pronounced decrease evident in specimens cured under MC regimen compared to those cured under WB. All the mixtures exhibited a smooth tension stiffening region after the initiation of first crack with a deflection capacity beyond L/150.

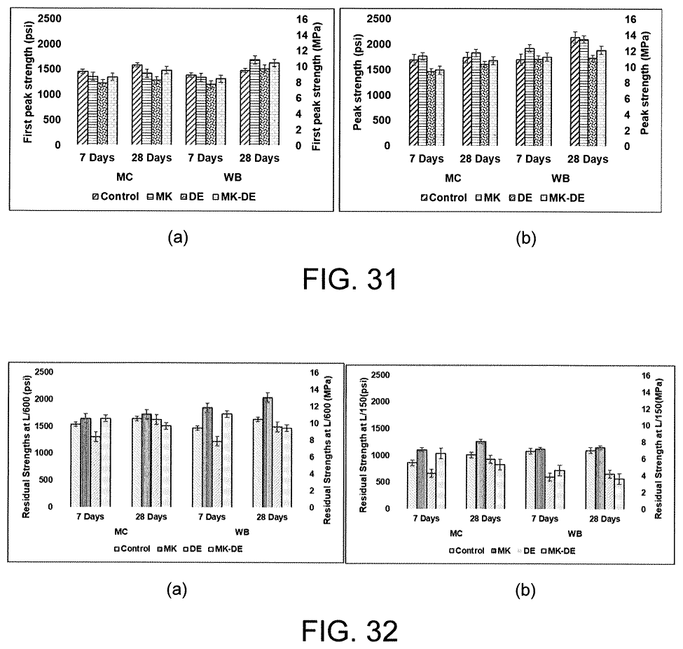

FIG. 31 presents the main flexural properties MOR and peak strength. In terms of MOR values, the control UHPC mixture performed better than the modified UHPC mixtures. The greatest MOR values of 1460 psi (10.13 MPa) and 1585 psi (10.92 MPa) at seven and 28 days, respectively were obtained by the control mixture cured under MC regimen. On the other hand, DE modified UHPC exhibited the lowest MOR values under MC curing regimen. DE modified UHPC cured under MC regimen resulted in the reduction of MOR by 17.5% and 14.9% at seven and 28 days, respectively when compared to control UHPC mixture.

All the mixtures cured under both MC and WB curing regimens exhibited greater MOR values at 28 days compared to those at seven days (FIG. 31). The WB curing regimen resulted in a decrease in the MOR values at seven days compared to 28 days for all mixtures, with values marginally lower than those cured under the MC regimen. In contrast, at 28 days, when cured under WB, there was a substantial increase in the MOR values in all the mixtures except the control mixture. MOR values of MK-, DE-, and MK-DE-modified mixtures were 17.65, 16.75, and 9.61% greater when compared to those cured under MC regimen. The initial decrease in MOR values at seven days under WB curing compared to MC regimen may be attributed to slower hydration rates and potential drying of samples, while the subsequent increase in MOR values at 28 days under WB curing suggests enhanced microstructure strengthening through prolonged hydration. However, the control mixture exhibited marginally lower MOR value at 28 days in WB curing compared to MC regimen. This can be attributed to slower pozzolanic reactivity and less efficient hydration kinetics inherent to fly ash, whereas the greater MOR values exhibited by UHPC mixtures containing MK or DE in WB curing might be the result of their higher pozzolanic reactivity and finer particle sizes, which facilitate enhanced flexural strength.

This significant improvement in MOR values can be attributed to the enhanced microstructure of the UHPC mixture resulting from the hydration of both MK and DE at later ages. The peak strengths at seven and 28 days of all four UHPC mixtures cured under MC and WB regimens were depicted in FIG. 31 (b). All the WB cured UHPC specimens had greater peak strengths than the MC cured specimens. The greatest peak strength of 2,145 psi (14.8 MPa) was exhibited by control UHPC mixture at 28 days when cured under WB curing regimen followed by MK modified UHPC. DE modified UHPC exhibited the lowest peak strengths when compared to control UHPC mixture by 14.9% and 8% at seven and 28 days respectively under MC curing regimen.

The residual strengths at deflections L/600 and L/150, deflections were depicted in FIG. 32. Among all the mixtures, MK modified UHPC cued under WB regimen for 28 days exhibited greatest residual strengths of 2,045 psi (14 MPa) and 1,155 psi (8 MPa) at L/600 and L/150 deflections, respectively, DE modified UHPC being the least. As in the case of MOR, there is no improvement in residual strengths of control mixture when cured under WB. Similarly, the WB cured UHPC mixtures containing DE displayed residual strengths lower than those of the MC cured DE modified UHPC at seven and 28 days. This trend suggests that the presence of DE does not contribute positively in terms of residual strengths.

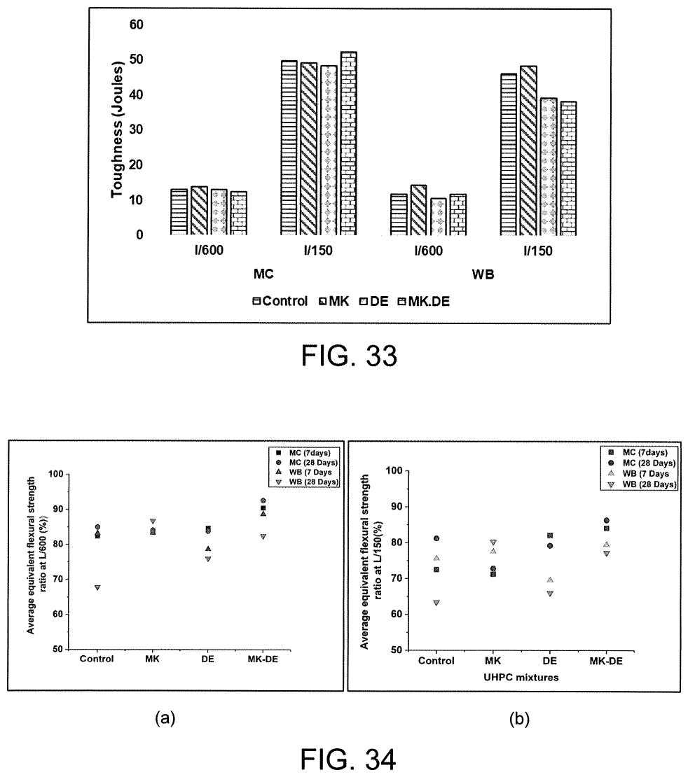

Toughness: To properly understand the energy absorption capacity of UHPC mixtures produced with different SCMs and cured under MC and WB curing regimens, toughness values were calculated for all the developed mixtures at deflections L/600 and L/150 and are presented in FIG. 33. At L/600 deflection, MK modified UHPC showed better performance than the control UHPC mixture by 6% and 14.4% in MC and WB curing regimens, respectively, while, MK-DE modified UHPC had the least toughness values at L/600. However, at deflection of L/150, the MK-DE modified UHPC mixture, cured under MC regimen, exhibited the greatest toughness value of 52.5 Joules at 28 days, which is 5% greater than that of the control UHPC mixture. Both MK and DE modified UHPC mixtures showed toughness values similar to the control UHPC mixtures at 28 days cured under MC curing regimen, with decreases of 1.2% and 2.6%, respectively. Whereas, in the WB curing regimen, at 28 days, MK-DE modified UHPC mixtures exhibited the lowest toughness value, with the DE modified UHPC mixture following closely. This suggests that DE has a negative effect on toughness when cured under WB conditions.

Equivalent flexural strength ratios: Equivalent flexural strength ratios (R_{T,n}^{D}) were calculated in accordance with ASTM 1609 to further characterize the flexural performance of UHPC mixtures containing alternative SCMs.

The ratio obtained offers a standardized measure of the relative flexural strength retained post-cracking at a specified deflection level. For instance, for control UHPC mixture, cured for 28 days under MC curing regimen, the R value is 81.2%. This indicates that 81.2% of the peak strength was still present at the deflection corresponding to L/150 deflection. FIG. 34(a) and FIG. 34(b) depicts the equivalent flexural strength ratios calculated at deflections corresponding to L/600 and L/150 respectively for all the mixtures cured under MC and WB regimens. As shown in FIG. 34 (a) and FIG. 34 (b) the R ratios are maximum for MC cured MK-DE modified UHPC mixture at 28 days and minimum for WB cured control UHPC mixture at 28 days. MK-DE modified UHPC mixture performed better than the control UHPC mixture in both the curing regimens at both seven and 28 days at both the deflections except in the case of WB cured MK-modified UHPC at 28 days. Moreover, at 28 days, MK modified UHPC cured under WB cuing regimen showed better performance than any other UHPC mixtures while DE modified UHPC mixture had the least equivalent flexural strength ratios. This trend persisted even at seven days, where the DE modified UHPC mixture exhibited lower values than any other UHPC mixtures. These results suggest that WB curing has a detrimental effect on the flexural strength of DE modified UHPC.

Splitting tensile strength and Modulus of Elasticity of UHPC mixtures: 4×8-inch (100×200 mm) cylindrical specimens for all the four UHPC mixtures, cured under MC curing regimen, were tested at 28 days to evaluate their splitting tensile strength (Table 10). The control UHPC mixture exhibited the greatest splitting tensile strength of 1440 psi (9.92 MPa). However, the MK modified UHPC mixture showed a decrease of 8.31% when compared to the control UHPC mixture. This reduction can be attributed to the low w/cm ratio and the low specific surface area of MK, which are known to affect the split tensile strength negatively. Furthermore, the split tensile strength of the DE modified UHPC decreased by 16.5% compared to the control mixture. This reduction in tensile strength is linked to the concrete's lower workability, which can result in a less compact UHPC mixture, ultimately leading to lower tensile strength. Whereas, this decrease was only 8.7% in MK-DE modified UHPC mixture when compared to control mixture.

Table 10 displays the average Poisson's ratio and modulus of elasticity values for the UHPC mixtures developed in this study following 28 days of moist curing. Among these, the control UHPC exhibited the greatest modulus of elasticity value of 5.5×10⁶ psi (37,930 MPa) with a Poisson's ratio of 0.22. In contrast, the DE modified UHPC exhibited a relatively lower modulus of elasticity (4.9×10⁶ psi/33,790 MPa)), demonstrating a reduction of 8% compared to the control mixture.

TABLE 10
Effect of split tensile strength, Poisons ratio,
and modulus of elasticity of UHPC mixtures

| | Split tensile | Poisons | Modulus of |
|---|---|---|---|
| Mixture | strength (psi) | ratio | Elasticity (psi) |
| Control | 1440 | 0.22 | 5.3 × 10⁶ |
| MK | 1325 | 0.21 | 5.2 × 10⁶ |
| DE | 1220 | 0.2 | 4.9 × 10⁶ |
| MK-DE | 1320 | 0.21 | 5.2 × 10⁶ |

Note:
1 psi = 0.00689476 MPa.

### CONCLUSIONS

After a rigorous optimization process, it was found that fly ash can be replaced completely with MK and DE but at an increased HRWRA dosage.

Under the MC regimen, the MK modified UHPC mixture exhibited the greatest compressive strength at 56 days, showcasing its effectiveness in enhancing long-term performance. Moreover, at 28 days, all the three modified UHPC mixtures demonstrated superior compressive strengths compared to the control mixture.

In the WB curing regimen, the MK modified UHPC mixture again displayed the greatest compressive strength at 56 days, while at 28 days, it outperformed the control mixture by 3.6%.

The MK-DE modified UHPC mixture, without SF and FA, yielded comparable results to the control UHPC mixture, suggesting its potential for practical and sustainable applications.

The comparable compressive strengths at later ages (56 Days) between WB and MC indicate that the initial acceleration in early-age strength under WB curing diminishes over time, suggesting that the WB regimen may not be necessary for sustainability considerations. However, if rapid strength gain is warranted, then WB curing may still be beneficial up to three days.

Curing regimens influenced flexural properties, initially causing marginal decreases under WB curing. However, extended WB curing substantially improved flexural performance for MK and DE modified UHPC mixes, offsetting initial strength decreases and enhancing microstructure development.

The research highlights that MK-modified UHPC excels in toughness regardless of curing method, whereas DE modification reduces toughness, especially with water bath curing, emphasizing the crucial role of both SCM's and curing techniques in determining UHPC's energy absorption capacity and flexural strength.

At 28 days, control UHPC exhibited the greatest splitting tensile strength, while DE modified UHPC experienced a notable reduction, followed by MK and MK-DE modified UHPCs. Furthermore, MK modified UHPC demonstrated the greatest MOE, while DE modified UHPC showed a relatively modest 8% reduction in MOE compared to the control mixture.

The present disclosure has been described with reference to example embodiments. Modifications and alterations will occur to others upon reading and understanding the preceding detailed description. It is intended that the present disclosure be construed as including all such modifications and alterations insofar as they come within the scope of the appended claims or the equivalents thereof.

1. A cementitious powder composition comprising:
portland cement;
sand; and
at least one material selected from the group consisting of ground granulated blast furnace slag, limestone powder, diatomaceous earth, and metakaolin.

2. The cementitious powder composition of claim 1, wherein the at least one material comprises ground granulated blast furnace slag and limestone powder.

3. The cementitious powder composition of claim 1, wherein the at least one material comprises diatomaceous earth and metakaolin.

4. A cement composition formed by mixing the cementitious powder composition of claim 1 with steel fibers, a high-range water reducing admixture, and water.

5. A cementitious powder composition comprising:
portland cement;
sand;
ground granulated blast furnace slag;
limestone powder;
silica fume; and
fly ash.

6. The cementitious powder composition of claim 5, wherein a weight ratio of limestone powder to sand is in a range of about 1:15 to about 1:7.

7. The cementitious powder composition of claim 5, wherein a weight ratio of limestone powder to sand is in a range of about 1:10 to about 1:8.

8. The cementitious powder composition of any one of claim 5, wherein a weight ratio of ground granulated blast furnace slag to portland cement is in a range of about 1:1 to about 1:7.

9. The cementitious powder composition of any one of claim 5, wherein a weight ratio of ground granulated blast furnace slag to portland cement is in a range of about 1:2 to about 1:5.

10. A cement composition formed by mixing the cementitious powder composition of claim 5 with steel fibers, a high-range water reducing admixture, and water.

11. A cementitious powder composition comprising:
portland cement;
sand;
silica fume;
metakaolin; and
diatomaceous earth.

12. The cementitious powder composition of claim 11, comprising from about 1 wt % to about 3 wt % of the fly ash.

13. The cementitious powder composition of claim 11, comprising from about 1 wt % to about 6 wt % of the diatomaceous earth.

14. The cementitious powder composition of claim 11, comprising from about 3 wt % to about 5 wt % of the diatomaceous earth.

15. The cementitious powder composition of claim 11, comprising from about 1 wt % to about 6 wt % of the metakaolin.

16. The cementitious powder composition of claim 11, comprising from about 3 wt % to about 5 wt % of the metakaolin.

17. The cementitious powder composition of claim 11, wherein a weight ratio of the metakaolin to the diatomaceous earth is in a range of about 1:3 to about 3:1.

18. The cementitious powder composition of claim 11, wherein a weight ratio of the metakaolin to the diatomaceous earth is in a range of about 1:2 to about 2:1.

19. The cementitious powder composition of claim 11, wherein a weight ratio of the metakaolin to the diatomaceous earth is about 1:1.

20. A cement composition formed by mixing the cementitious powder composition of claim 11 with steel fibers, a high-range water reducing admixture, and water.
